(19) United States
(12) Patent Application Publication
(10) Pub. No.: US 2024/0395173 A1
(43) Pub. Date: Nov. 28, 2024

(54) LABEL PROTECTION RAIL WITH UNIVERSAL SLOT PATTERN

(71) Applicant: K-International, Inc., Waukegan, IL (US)

(72) Inventor: Garrett Wagner, Grayslake, IL (US)

(73) Assignee: K-International, Inc., Waukegan, IL (US)

(21) Appl. No.: 18/674,688

(22) Filed: May 24, 2024

Related U.S. Application Data
(60) Provisional application No. 63/504,699, filed on May 26, 2023.

(51) Int. Cl. G09F 3/18

(52) U.S. Cl. CPC G09F 3/18

(57) ABSTRACT

A protection rail is described that includes apertures that may be located at positions along the protection rail so as to correspond to one or more apertures of the shelving unit. The dimensions of the apertures and associated spatial relationships, as well as the spatial relationship to one or more other groups of apertures, may be configured such that the protection rail may provide a layout of apertures adapted to allow the protection rail to be mounted to various types of shelving units having different aperture layouts, different sized apertures, and/or different shaped apertures. This advantageously provides the protection rail with a universal aperture pattern that allows the protection rail to be universally used for various types of commercially available shelving units.

### CROSS REFERENCE TO RELATED APPLICATIONS

This patent application claims priority to, and the benefit of, U.S. Provisional Patent Application No. 63/504,699, filed May 26, 2023, which is incorporated herein by reference in its entirety.

### BACKGROUND

Shelving units and labels mounted therein are commonly subjected to physical impacts, such as from people or objects encountering the respective shelving unit. For example, in commercial environments, people, shopping carts, or other objects may impact the shelving unit(s), and/or signage (e.g., label(s), signs, etc.) mounted to the shelving unit(s), causing damage to the shelving unit(s) and/or signage (e.g., damaging and./or dislodging one or more labels). Given the non-uniformity of commercially available shelving units, after-market protection means are costly to manufacture and deploy.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a protection rail according to the disclosure mounted to a shelving unit.

FIG. 2A is a perspective view of a protection rail according to the disclosure.

FIG. 2B is a perspective view of a protection rail according to the disclosure that includes a fastener, such as a fastening strip.

FIG. 3 is a side view of the protection rail of FIG. 2, the opposite side view being a mirror image.

FIG. 4 is a perspective view of a protection rail according to the disclosure with the shield portion rotated about its hinge.

FIG. 5 is a side view of the protection rail of FIG. 4.

FIG. 6 is a perspective view of the protection rail of FIG. 2.

FIG. 7 is a cross-sectional view of the protection rail of FIG. 1 taken along A-A.

FIG. 8A is a bottom view of a protection rail according to the disclosure that includes exemplary dimensions.

FIG. 8B is an enlarged partial view of portion “8B” shown in FIG. 8A that includes exemplary dimensions.

FIG. 8C is a side view of the protection rail of FIG. 8A that includes exemplary dimensions.

FIGS. 9-16 show additional views of a protection rail, with FIG. 9 being a perspective view of a protection rail according to the disclosure in an environment of use mounted to a shelving unit, with the shield portion being rotated about its hinge.

FIG. 10 is a perspective view of a protection rail according to the disclosure.

FIG. 11 is a right-side view of a protection rail according to the disclosure.

FIG. 12 is a left-side view of a protection rail according to the disclosure.

FIG. 13 is a top plan view of a protection rail according to the disclosure.

FIG. 14 is a bottom view of a protection rail according to the disclosure.

FIG. 15 is a front view of a protection rail according to the disclosure.

FIG. 16 is a rear view of a protection rail according to the disclosure.

FIGS. 17-23 show additional views of a protection rail, with FIG. 17 being a perspective view of a protection rail according to FIG. 10 with the shield portion in an unrotated orientation.

FIG. 18 is a right-side view of a protection rail according to the disclosure.

FIG. 19 is a left-side view of a protection rail according to the disclosure.

FIG. 20 is a top plan view of a protection rail according to the disclosure.

FIG. 21 is a bottom view of a protection rail according to the disclosure.

FIG. 22 is a front view of a protection rail according to the disclosure.

FIG. 23 is a rear view of a protection rail according to the disclosure.

FIGS. 24-31 show additional views of a protection rail, with FIG. 24 being a perspective view of a protection rail according to the disclosure in an environment of use mounted to a shelving unit, with the shield portion being rotated about its hinge and having mounting apertures in an alternative arrangement.

FIG. 25 is a perspective view of a protection rail according to the disclosure.

FIG. 26 is a right-side view of a protection rail according to the disclosure.

FIG. 27 is a left-side view of a protection rail according to the disclosure.

FIG. 28 is a top plan view of a protection rail according to the disclosure.

FIG. 29 is a bottom view of a protection rail according to the disclosure.

FIG. 30 is a front view of a protection rail according to the disclosure.

FIG. 31 is a rear view of a protection rail according to the disclosure.

FIGS. 32-38 show additional views of a protection rail, with FIG. 32 being a perspective view of a protection rail according to FIG. 24 with the shield portion in an unrotated orientation and having mounting apertures in an alternative arrangement.

FIG. 33 is a right-side view of a protection rail according to the disclosure.

FIG. 34 is a left-side view of a protection rail according to the disclosure.

FIG. 35 is a top plan view of a protection rail according to the disclosure.

FIG. 36 is a bottom view of a protection rail according to the disclosure.

FIG. 37 is a front view of a protection rail according to the disclosure.

FIG. 38 is a rear view of a protection rail according to the disclosure.

FIG. 39 is a perspective view of a protection rail according to the disclosure with the shield portion rotated about its hinge.

FIG. 40 is a perspective view of a protection rail according to the disclosure.

FIG. 41 is a top plan view of the protection rail of FIG. 40.

FIG. 42 is a perspective view of the protection rail of FIG. 40 having mounting apertures in an alternative arrangement.

FIG. 43 is a top plan view of the protection rail of FIG. 42.

FIG. 44A is a top plan view of the protection rail according to the disclosure with example mounting aperture locations shown in broken lines.

FIG. 45B is an enlarged partial view of FIG. 44A showing the mounting aperture locations.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

According to aspects of the disclosure, the apertures of the protection rail may be located at positions along the protection rail so as to correspond to one or more apertures of the shelving unit. For example, the dimensions of the apertures and associated spatial relationships, as well as the spatial relationship to one or more other groups of apertures, may be configured such that the protection rail according to the disclosure may provide a layout of apertures adapted to allow the protection rail to be mounted to various types of shelving units having different aperture layouts, different sized apertures, and/or different shaped apertures (e.g., diamond shaped vs. circular shaped). This advantageously provides the protection rail according to disclosure with a universal aperture pattern that allows the protection rail to be universally used for various types of commercially available shelving units, thereby reducing production costs and the requirement to have specialized protection rails for each of the commercially available shelving units.

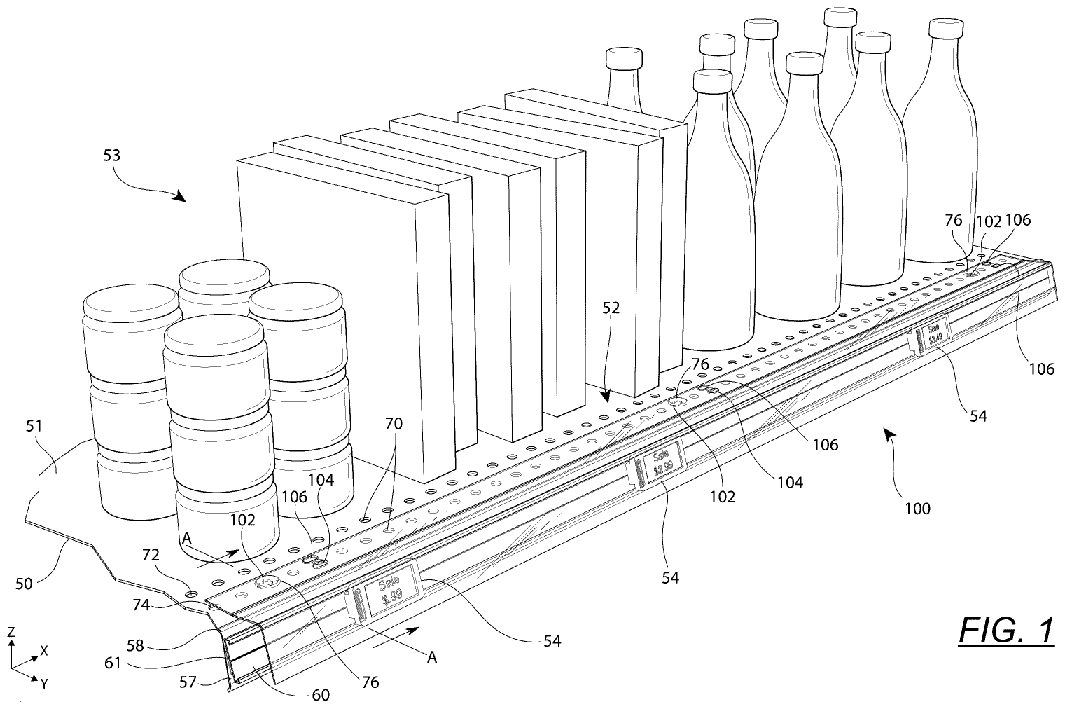

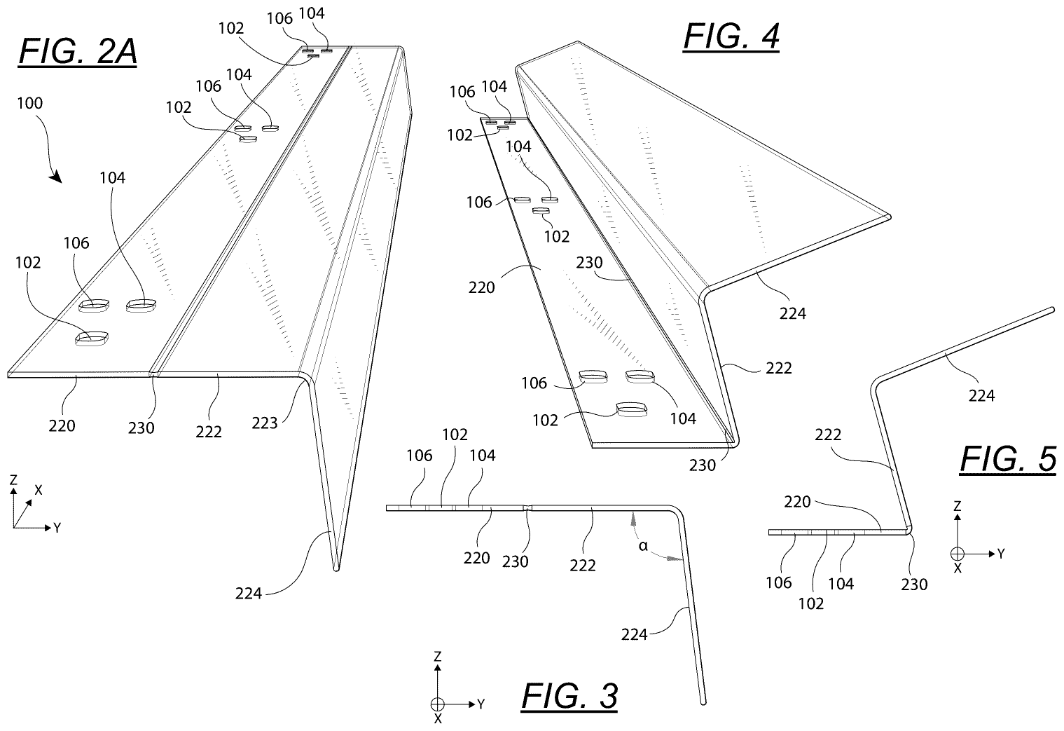

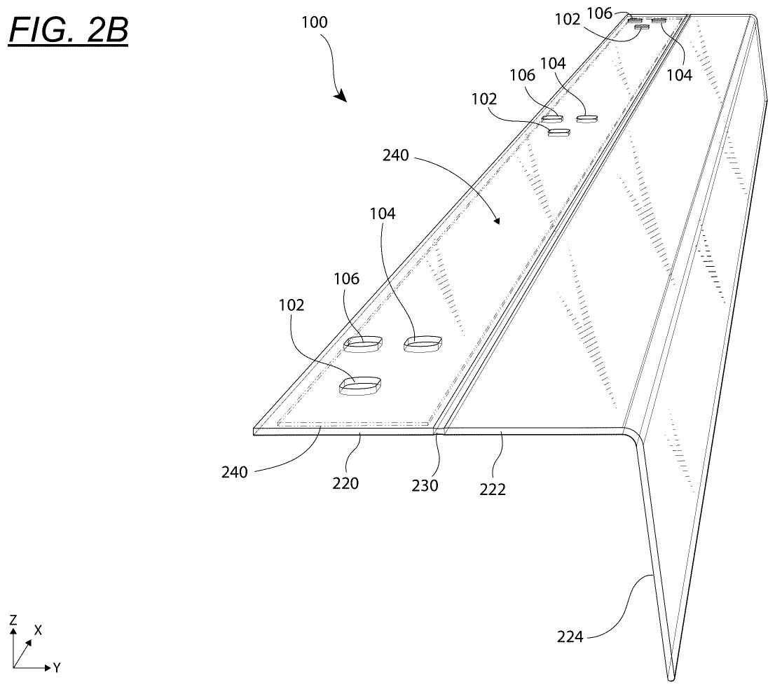

As shown in FIG. 1, the label protection rail 100 may be permanently or removably attached (or otherwise mounted) to a shelving unit (shelf) 50 that is adapted to support one or more objects 53 (e.g., commercial goods) on its upper surface 51. The protection rail 100 may be mounted to the front portion 52 of the shelving unit 50 and extend to at least partially cover a front edge 57 (e.g., ticket strip) of the shelving unit 50. For example, a shield portion 224 (FIG. 2) of the protection rail 100 may extend and at least partial cover a front edge 57 (e.g., ticket strip) of the shelving unit 50.

The protection rail 100 may be adapted to protect or otherwise shield the shelving unit 50, for example, from damage (e.g., resulting from physical contact to the shelving unit), as well as protect/shield one or more labels 54, signage, and/or one or more accessories mounted on the shelving unit 50 (e.g., on the front edge 57 of the shelving unit 50). The label(s) 54 may include an electronic shelf label (ESL) 54, but is not limited thereto and the label(s) 54 may include other non-electronic labels. The label(s) 54 may be mounted directly to the shelving unit 50. The label(s) 54 may be mounted to the shelving unit 50 using one or more label holders, such as label holder 60. The label holder 60 may be adapted to removably hold the label(s) 54 to the shelving unit 50. The label holder 60 may be permanently or removably mounted to the shelving unit 50, such as to the front edge 57 (e.g., ticket strip) of the shelving unit 50 using one or more fasteners 61. The fastener(s) 61 may include adhesive (e.g., adhesive strip), one or more magnets (e.g., magnetic strip), hook-and-loop fastener(s), and/or one or more other fasteners. Similar fastener(s) may be used for directly mounting the label(s) 54 to the shelving unit 50. The label holder 60 may include, for example, a label holder as described in U.S. Pat. No. 11,127,318, which is incorporated herein by reference in its entirety.

The protection rail 100 may be configured to extend from the front edge 57 of the shelf to hang over and in front of the label(s) 54 positioned on the front edge surface 57 of the shelf 50 to protect label(s) 54 positioned behind the protection rail 100. For example, the protection rail 100 may protect the label(s) 54 from physical contact that may damage the label(s) 54, cause the label(s) 54 to be misaligned, dislodged, and/or knocked of the shelving unit 50. The label(s) 54 may be a printed label, an electronic shelf label (ESL), or other types of labels.

The protection rail 100 may be transparent so as to allow the label(s) 54 positioned behind the protection rail 100 to be visible through the protection rail 100. The protection rail 100 may be opaque or semi-transparent in other aspects. Some portions of the protection rail 100 may be transparent while other portion(s) may be opaque or semi-transparent. For example, the shield portion 224 (FIG. 2A) may be transparent while the mounting portion 220 and/or base portion 22 may be opaque or semi-transparent.

The protection rail 100 may be made of vinyl, plastic, or other material(s). In one or more aspects, the protection rail 100 is made of Polyethylene terephthalate glycol (PETG).

The shelving unit 50 may include one or more apertures 70 adapted to receive one or more fasteners 76. The apertures 70 may be arranged in more or rows 72, 74, and/or in one or more other patterns. In the illustrated example, the apertures 70 are arranged in a first row 72 and a second row 74. The apertures 70 may be uniformly or non-uniformly spaced. For example, the apertures may be arranged with 0.5 inch spacing, 0.75 inch spacing, 1.0 inch spaced, etc. In the illustrated example, the aperture spacing and the spacing between the rows 72 and 74 is equal. The apertures 70 may be, for example, circular, rectangular, square, diamond-shaped, oval-shaped, stadium-shaped, etc. The number of rows and/or columns of apertures 70 may be different. The apertures 70 may be elongated to form slots. The circular-shaped apertures 70 in the illustrated example may be dimensioned to have a 0.25 inch diameter, but are not limited thereto.

Although the illustrated examples include apertures 70 of the same shape and size, the apertures 70 may include a combination of two or more different shaped apertures (e.g., a combination of circular and square apertures) and/or different sized apertures. The circular-shaped apertures 70 in the illustrated example may be dimensioned to have a 0.25 inch diameter, but are not limited thereto.

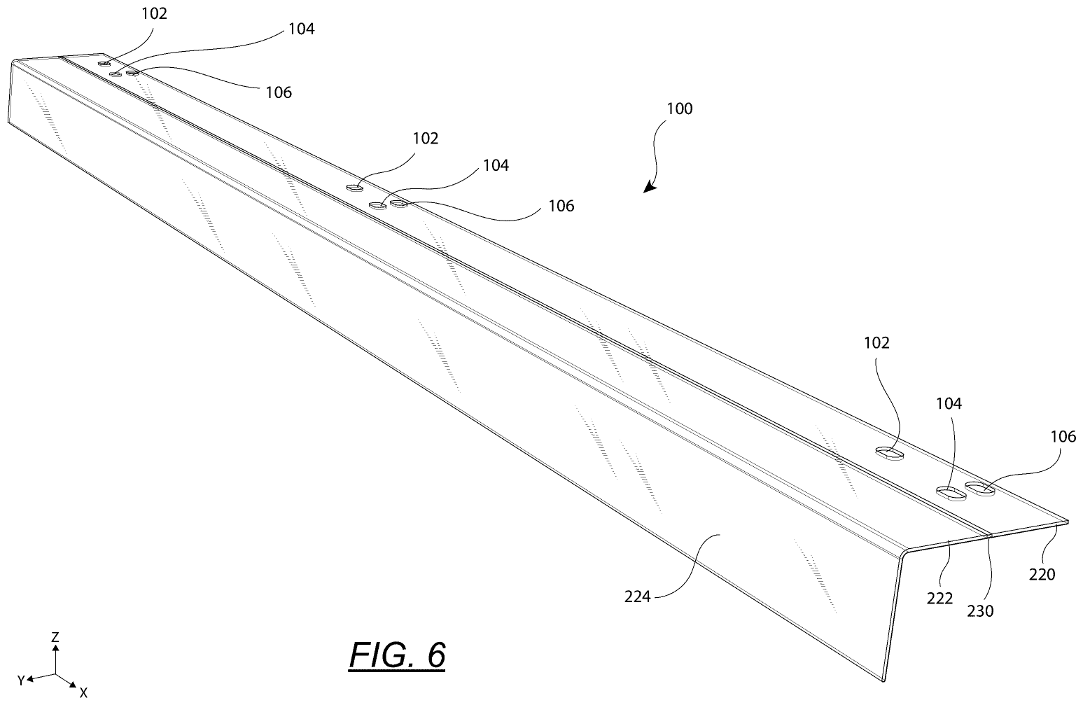

With reference to FIGS. 2-7, the protection rail 100 may include a mounting portion 220, a base portion 222, and a shield portion 224. The mounting portion 220 may be rotatably connected to the base portion 222 via hinge 230. The hinge 230 may be a flexible hinge made of, for example, a flexible rubber. The hinge 230 may have a durometer scale hardness of 60-70 Shore A, but is not limited thereto. The hinge 230 may extend (e.g. continuously) along the length of the protection rail 100. In one aspect, the hinge is discontinuous and includes multiple hinge sections arranged along the length of the protection rail 100. The base portion 222 may be rotated about the hinge 230 with respect to the mounting portion 220. This rotation allows the base portion 222 to be lifted upward (e.g. above a plane of tope surface 51 of the shelf 50). With reference to FIGS. 4-5, the shield portion 224 connected to the base portion 222 may also be lifted upward (along with the base portion 222) using the hinge 230 to allow for access to, for example, the label(s) 54 disposed behind the shield portion 224. In this configuration, the mounting portion 220 is connected to a top surface 51 of the shelf 50 (e.g. parallel to the plane of the top surface 51 of the shelf 50) and is connected to the base portion 222 by the hinge 230. The hinge 230 may be adapted to rotate from zero degrees (the orientation shown in FIGS. 2-3) backwards as shown in FIGS. 4-5. For example, the hinge 230 may be adapted to rotate a “negative” 180 degrees. Additionally, or alternatively, the hinge 230 may be adapted to rotate (e.g., forward) from zero degrees (the orientation shown in FIGS. 2-3) to “positive” 180 degrees towards the front edge 57 of the shelving unit 50.

The shield portion 224 may have an angled relationship with respect to the base portion 222, where the shield portion 224 is connected to the base portion 222 via a bend 223. In this example, the base portion 222 may be angled (e.g., oblique) with respect to the shield portion 224 at an angle α. The angle α may be 97 degrees in an exemplary aspect, but is not limited thereto. The angle α may be another angle dimension in one or more other aspects. For example, the angle α may be 85 degrees, 87 degrees, 90 degrees, or 95 degrees. In one or more aspects, the angle α may be set based on (e.g., set so the angle α corresponds to) an orientation of one or more components of the shelving unit 50 or other component(s) connected thereto, such as the: front edge 57, the label 54, and/or the holder 60. In one or more aspects, the angle α may be set based on (e.g., to correspond to) an angle of the front edge 57 (e.g., with respect to the top surface 51), an angle of the label 54, and/or an angle of the holder 60. For example, the angle α may be set such that the shield portion 224 (e.g., the planar portion of the shield portion 224) is parallel to the front edge 57 (e.g., the plane in which the front edge 57 lies), an angle of the label 54 (e.g., the plane in which the front surface of the label 54 lies), and/or an angle of the holder 60 (e.g., the plane in which the front surface of the holder 60 lies).

The bend 223 may be constructed as a hinge, which may be similar to hinge 230 in one or more aspects. Additionally, or alternatively, the base portion 222 and/or the shield portion 224 may include one or more hinges, which may be similar to hinge 230.

A first end of the base portion 222 is connected to the hinge 230 and a second end opposite the first end is connected to the shield portion. The attachment portion may include two more flexible hinges in one or more aspects. In one or more aspects, the shield portion may additionally or alternatively include one or more flexible hinges. In one or more aspects, the shield portion may connect to the attachment portion (e.g., to the base portion 222 of the attachment portion) by a flexible hinge. In this example, the shield portion may be angularly arranged (e.g., at 97 degrees) with respect to the attachment portion via the flexible hinge. The flexible hinge may be made of a flexible vinyl, plastic, or other material(s) that is more flexible than the material forming the other portions of the protection rail.

Similarly, the protection rail 100 may include one or more apertures 102, 104, 106. The apertures 102, 104, 106 may be uniformly or non-uniformly spaced. The apertures 102, 104, 106 may be circular, rectangular, square, diamond-shaped, oval-shaped, stadium-shaped, etc. The apertures 102, 104, 106 may be elongated to form slots. Although the illustrated examples include apertures 102, 104, 106 of the same shape (e.g., stadium shaped) and size, the apertures 102, 104, 106 may include a combination of two or more different shaped apertures and/or different sized apertures. The number of apertures is not limited to the illustrated examples.

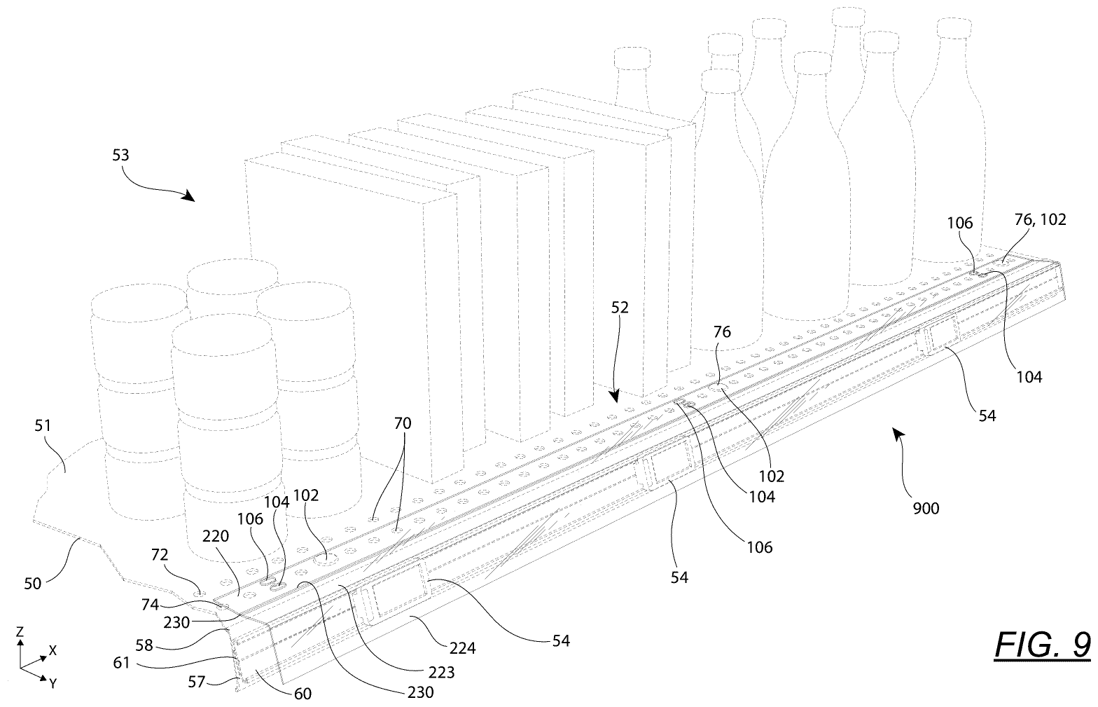

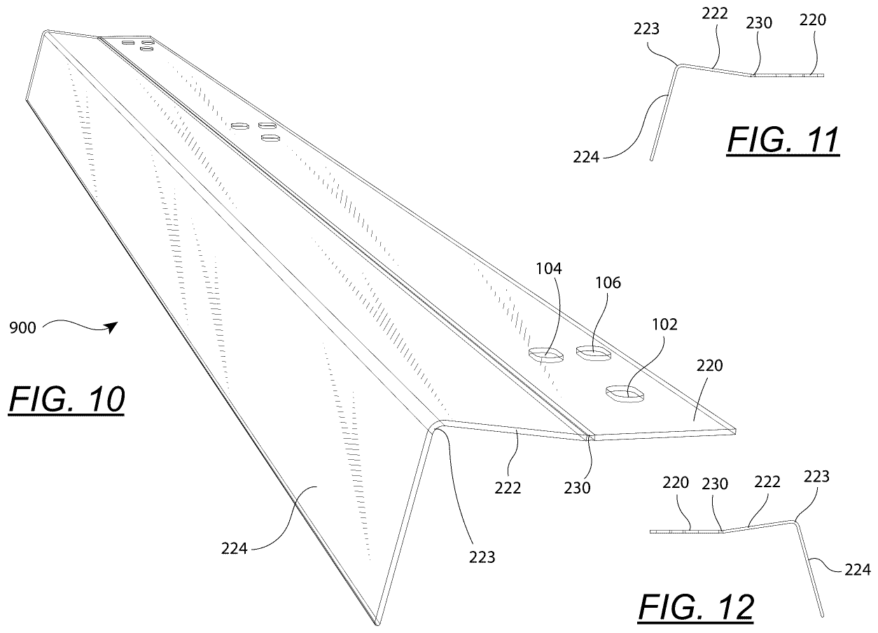

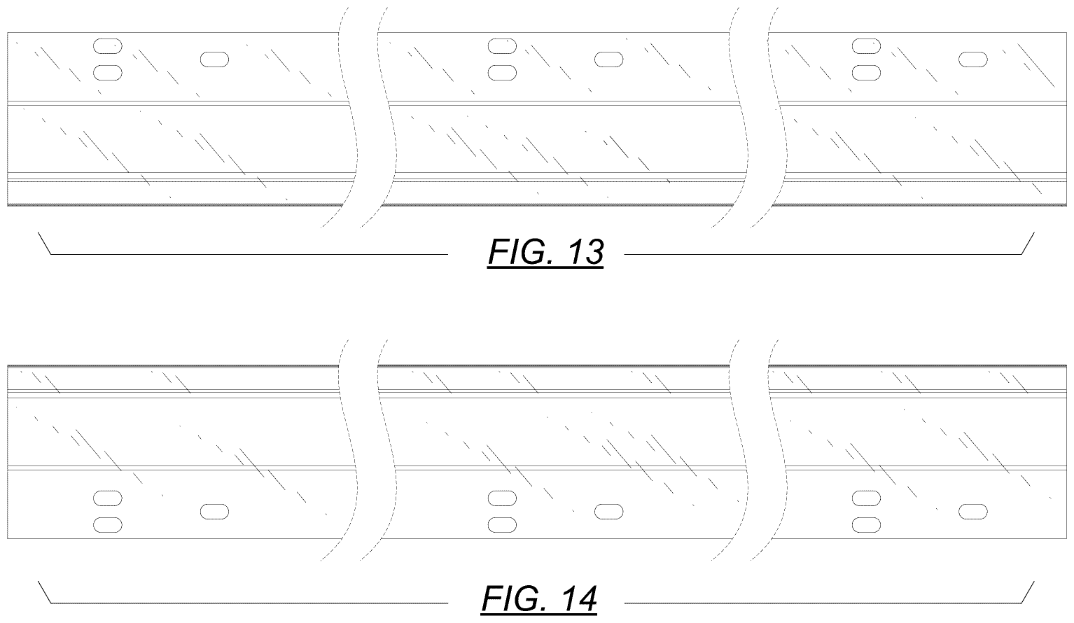

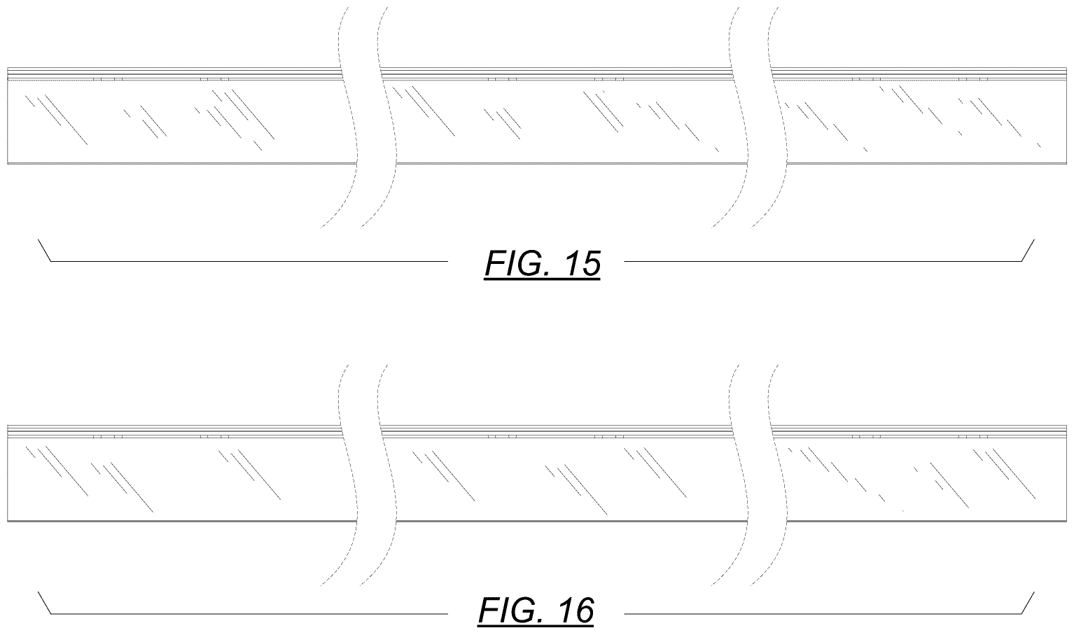

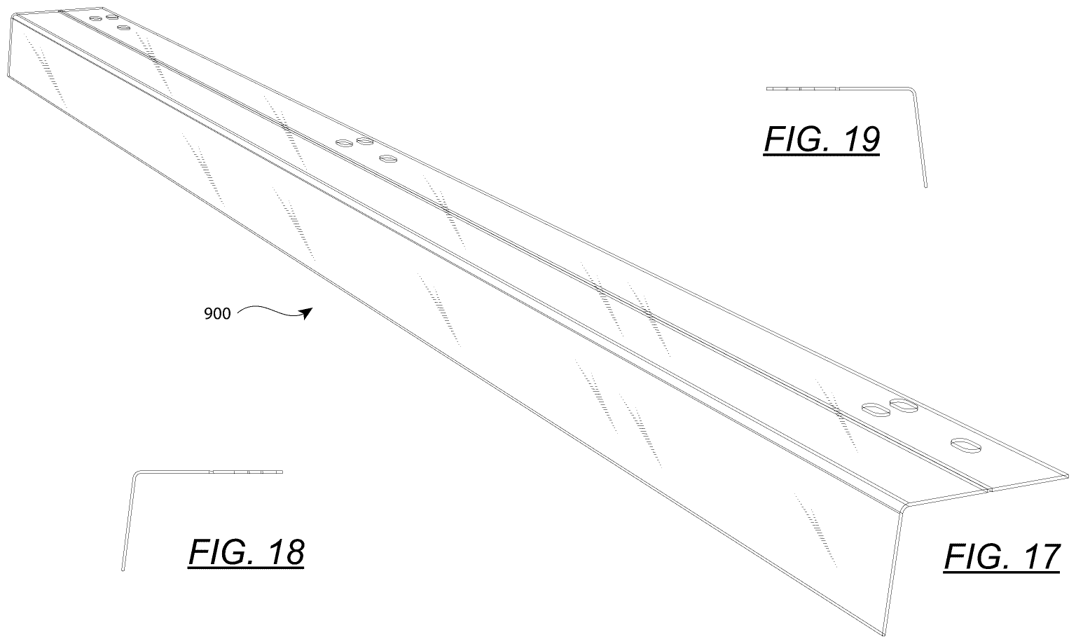

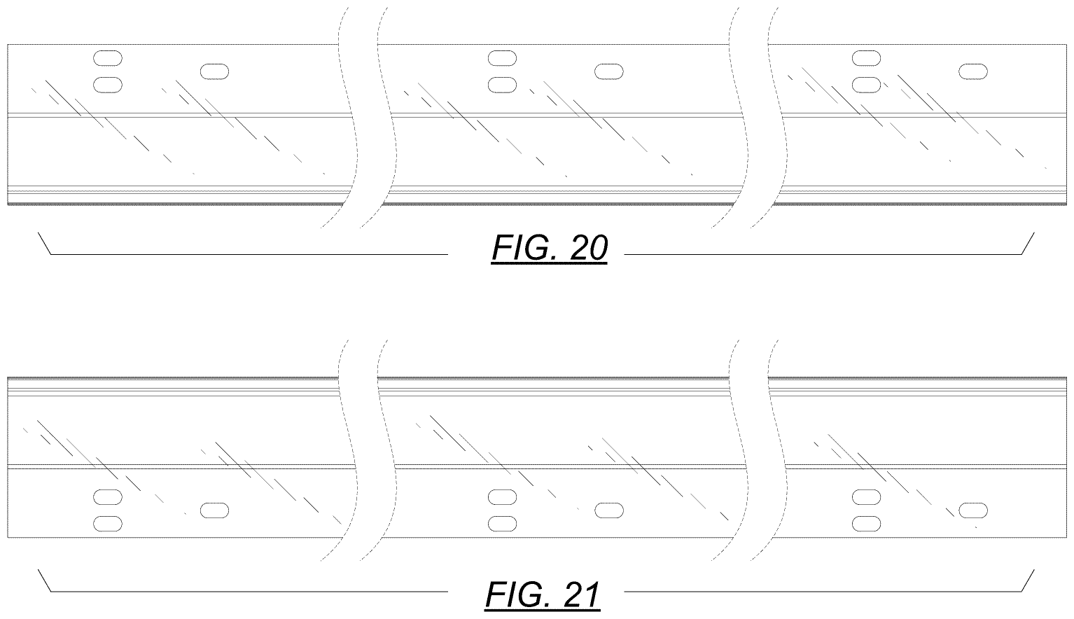

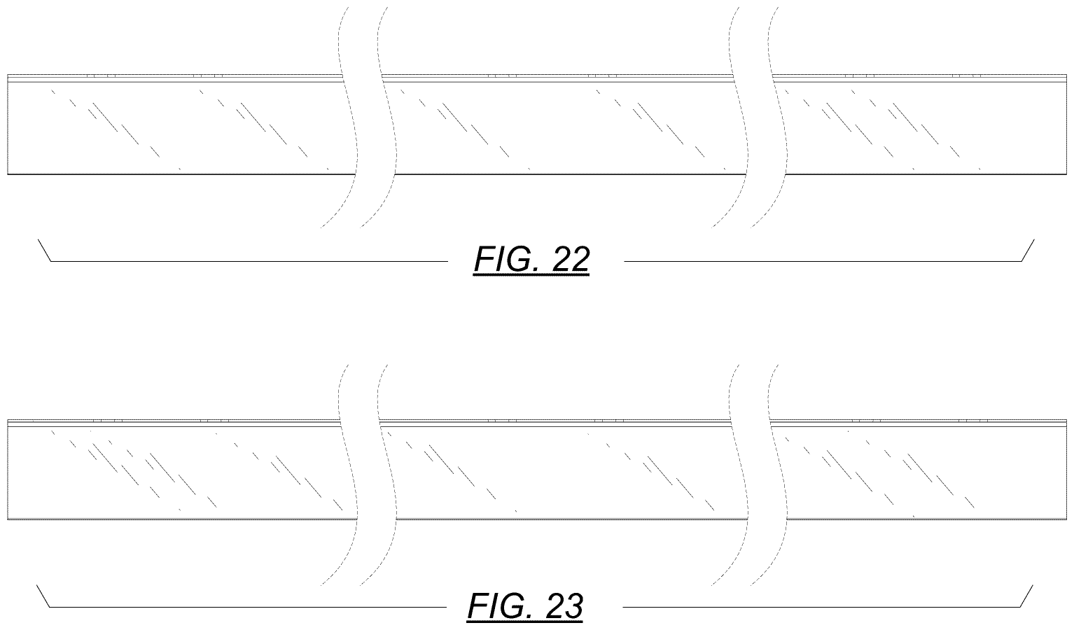

As shown in FIGS. 1-6, the apertures 102, 104, 106 of the protection rail 100 may be arranged as a group of multiple apertures. For example, a group may include aperture 102, aperture 104, and aperture 106, forming a group of three apertures. As shown, apertures 104 and 106 may be arranged and spaced in the latitudinal (Y-axis) direction such that their latitudinal (short) axes are parallel and coincide. The aperture 102 may be spaced from the apertures 104 and 106 in the longitudinal (X-axis) direction. The aperture 102 may be positioned in the latitudinal (Y-axis) direction such that the apertures 104 and 106 are equally spaced from the longitude axis of the aperture 102. FIGS. 9-23 so protection rail 900 that is similar to protection rail 100 but the aperture groups are rotated 180 degrees with respect to the orientation of the aperture groups of the protection rail 100 (e.g., the aperture group of protection rail 900 is a mirror image of the corresponding aperture group of protection rail 100). For example, for the protection rail 100 includes aperture 102 that is spaced from apertures 104, 106 (of the same aperture group) in the negative X-direction, while for the protection rail 900, aperture 102 is spaced from apertures 104, 106 (of the same aperture group) in the positive X-direction.

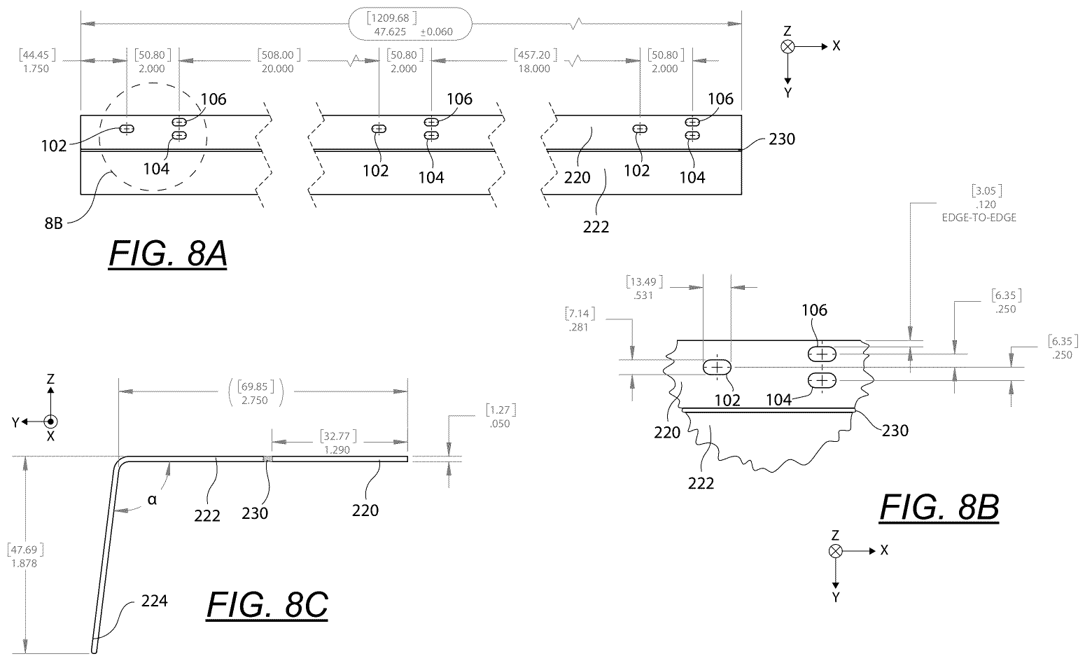

As shown in FIGS. 8A-8C, the apertures 102, 104, 106 may have a length in the longitudinal (X-axis) direction of 0.531 inches and a width in the latitudinal (Y-axis) direction of 0.281 inches. The distances shown in FIGS. 8A-8C are presented in inches, with corresponding dimensions in millimeters shown in brackets. The angle α may be 97 degrees in an exemplary aspect. The protection rail 100 may have a length (in the longitudinal (X-axis) direction) of 47.625 inches and/or a thickness (in the Z-axis direction) of 0.05 inches. The aperture 102 may be spaced from apertures 104, 106 a distance of 2.0 inches (along the x-axis direction) measured from the center of the aperture 102 to the centers of apertures 104, 106. The first group of apertures 102, 104, 106 may be spaced from the second group of apertures 102, 104, 106 a distance of 20.0 inches (along the x-axis direction) measured from the centers of apertures 104, 106 of the first group to the center of the aperture 102 of the second group. The second group of apertures 102, 104, 106 may be spaced from the third group of apertures 102, 104, 106 a distance of 18.0 inches (along the x-axis direction) measured from the centers of apertures 104, 106 of the second group to the center of the aperture 102 of the third group.

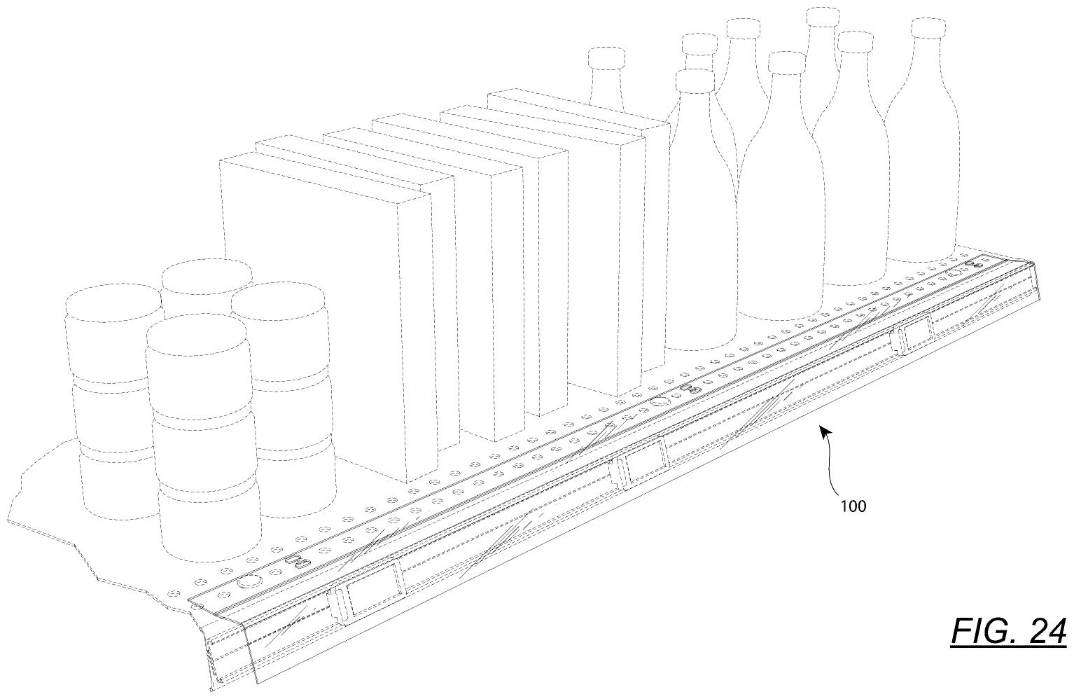

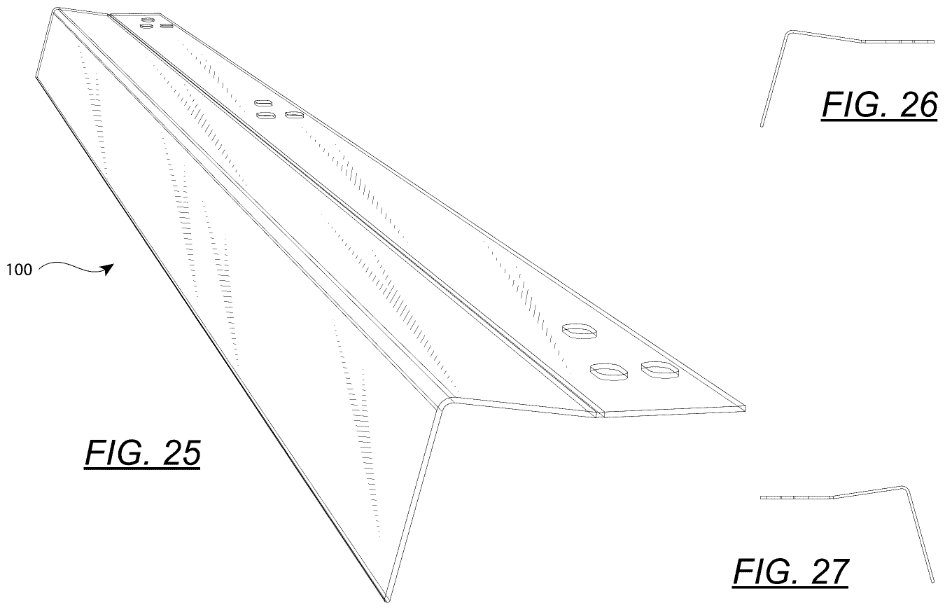

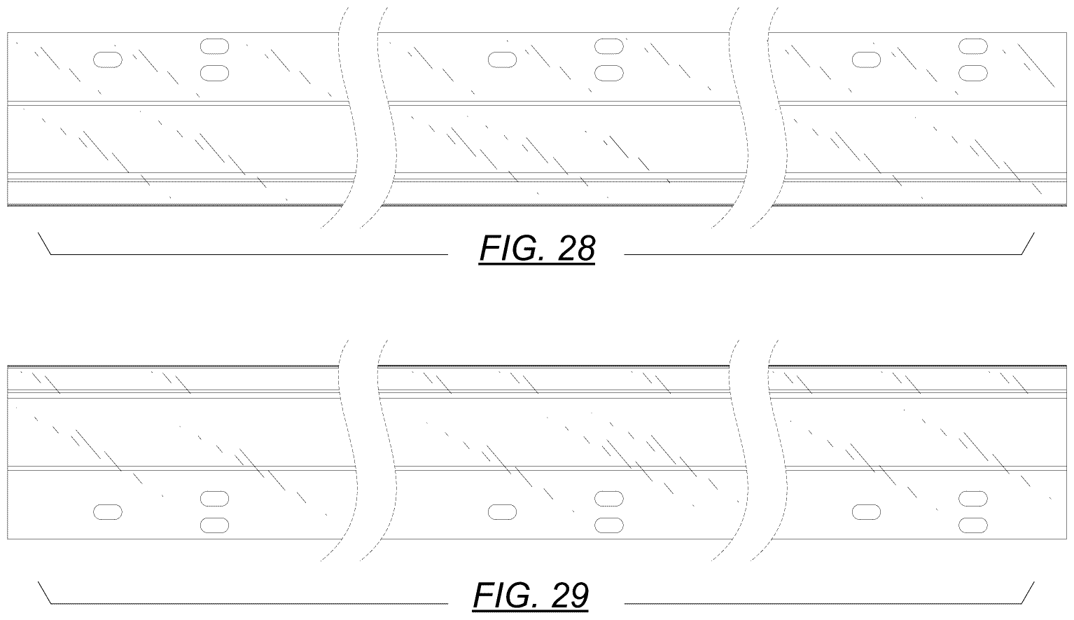

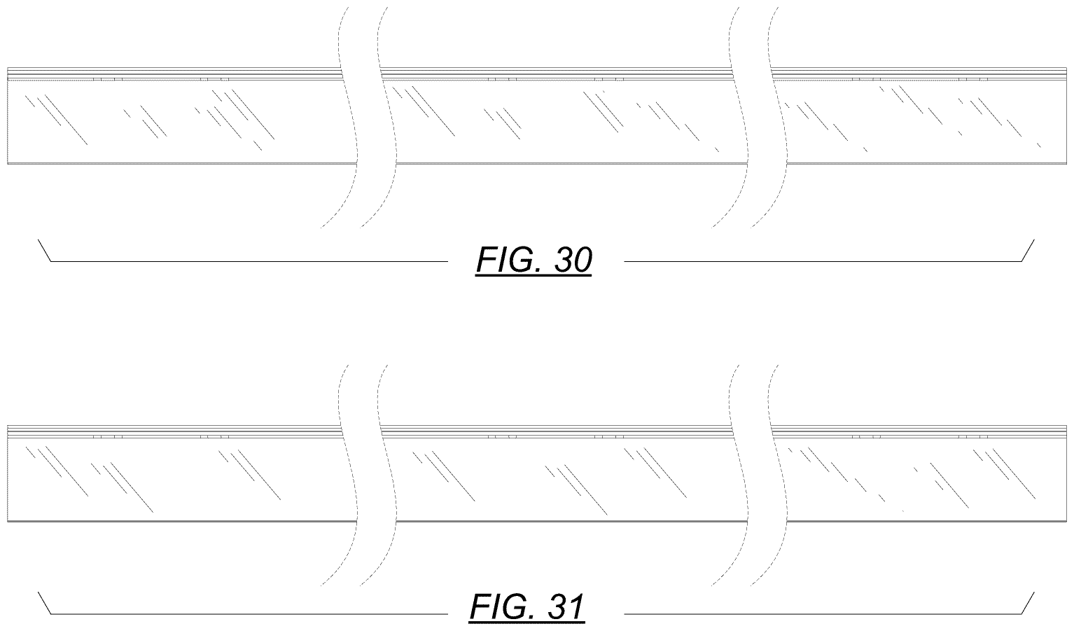

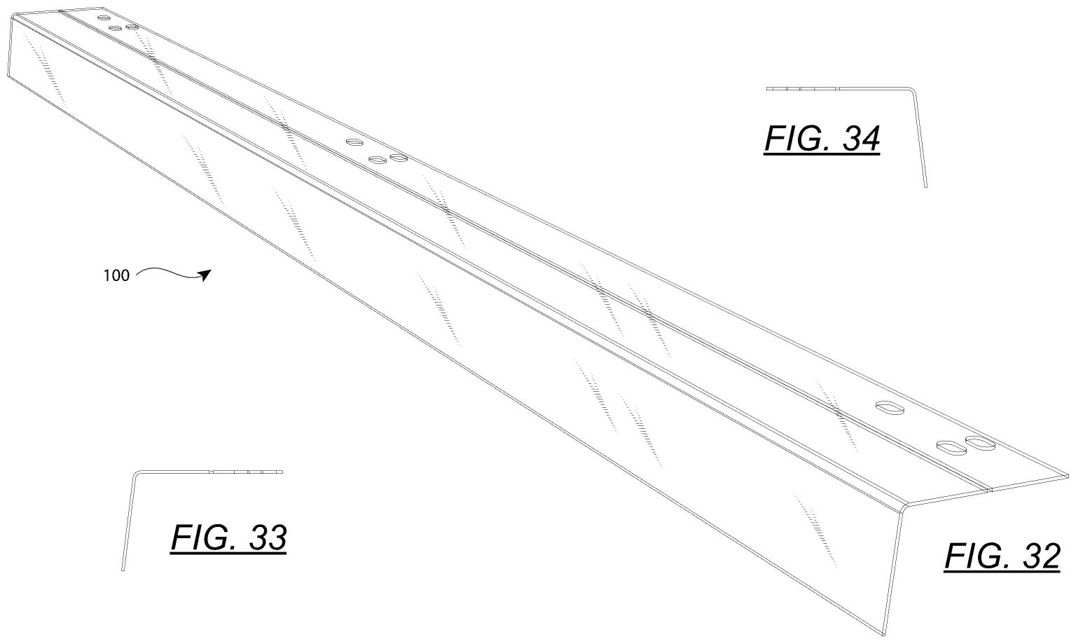

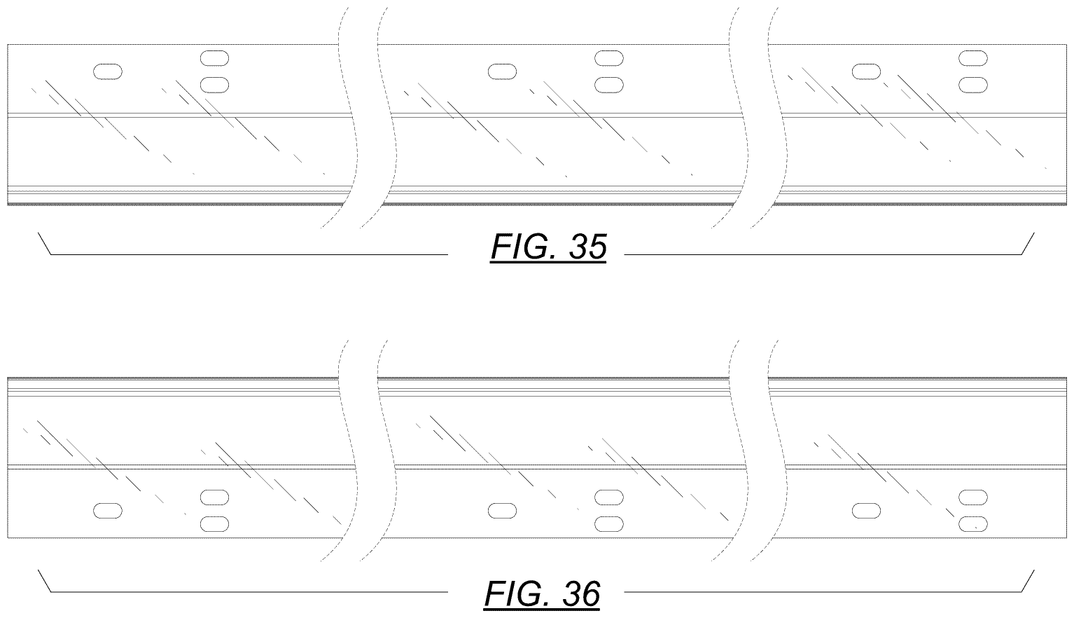

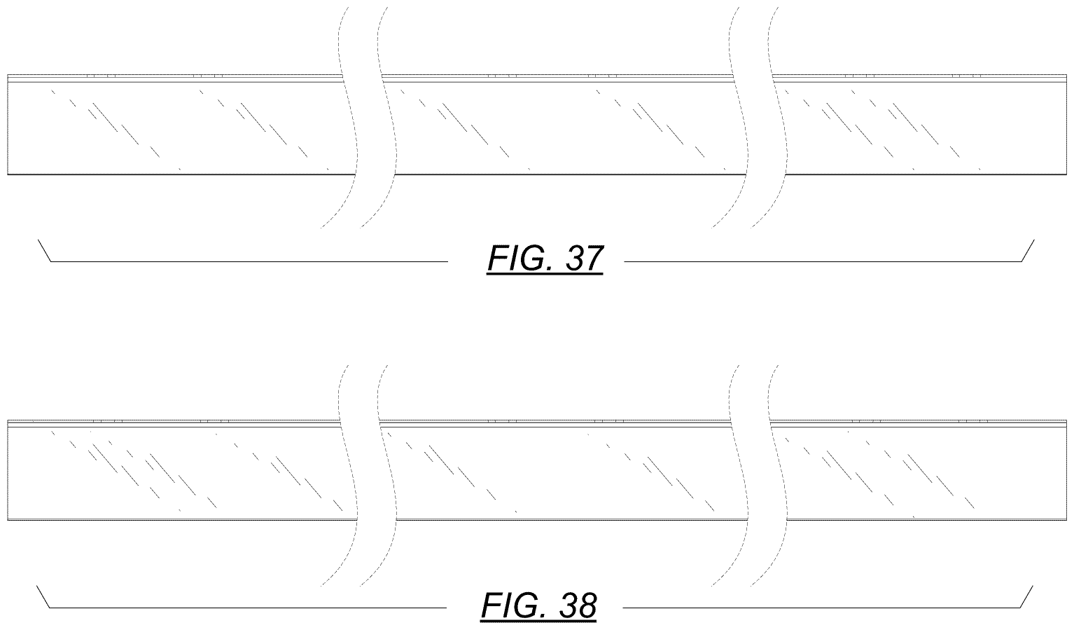

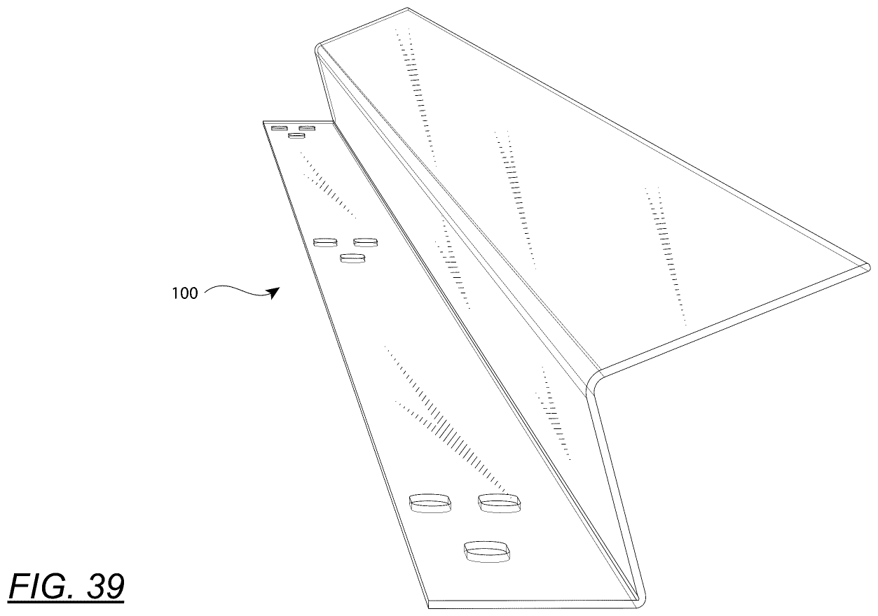

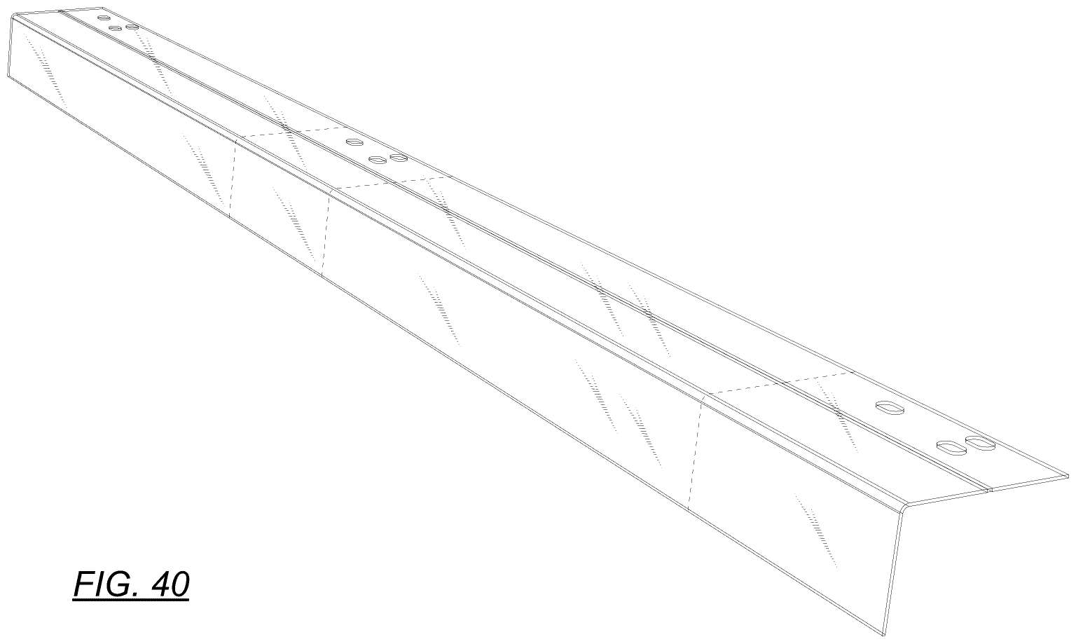

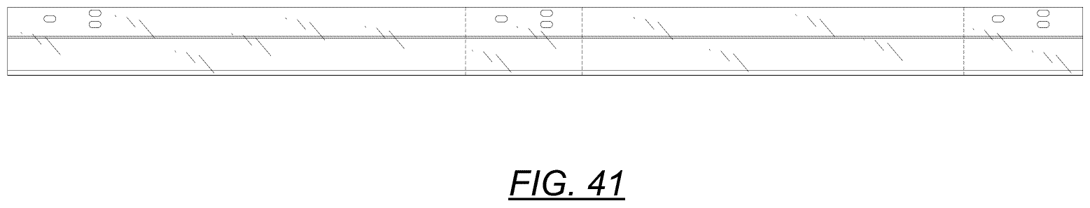

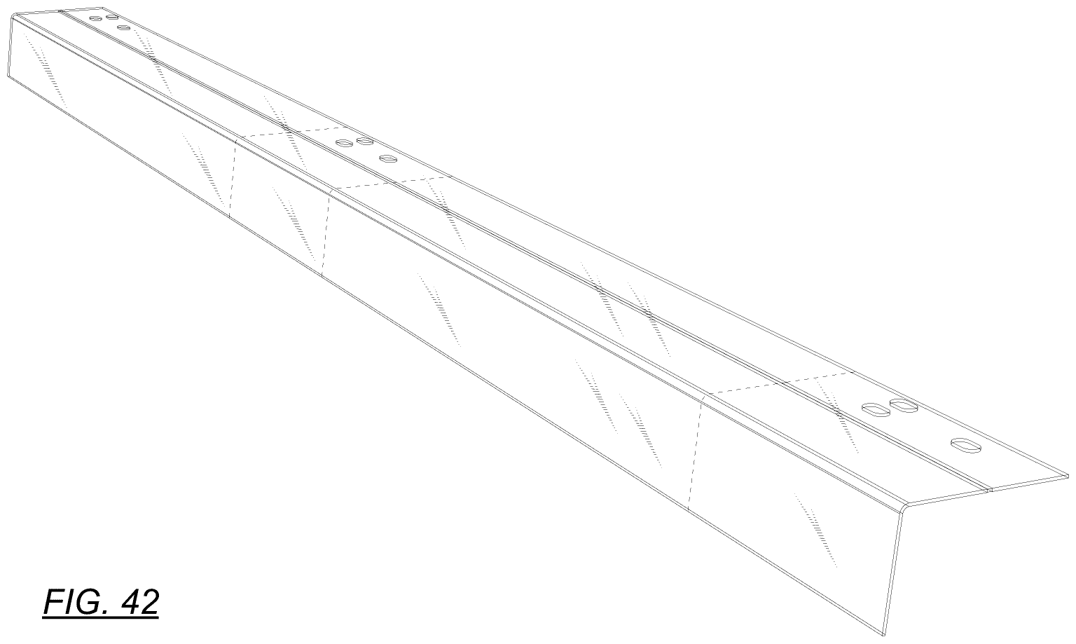

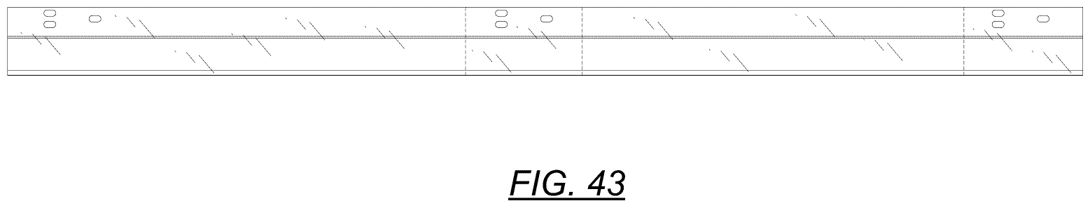

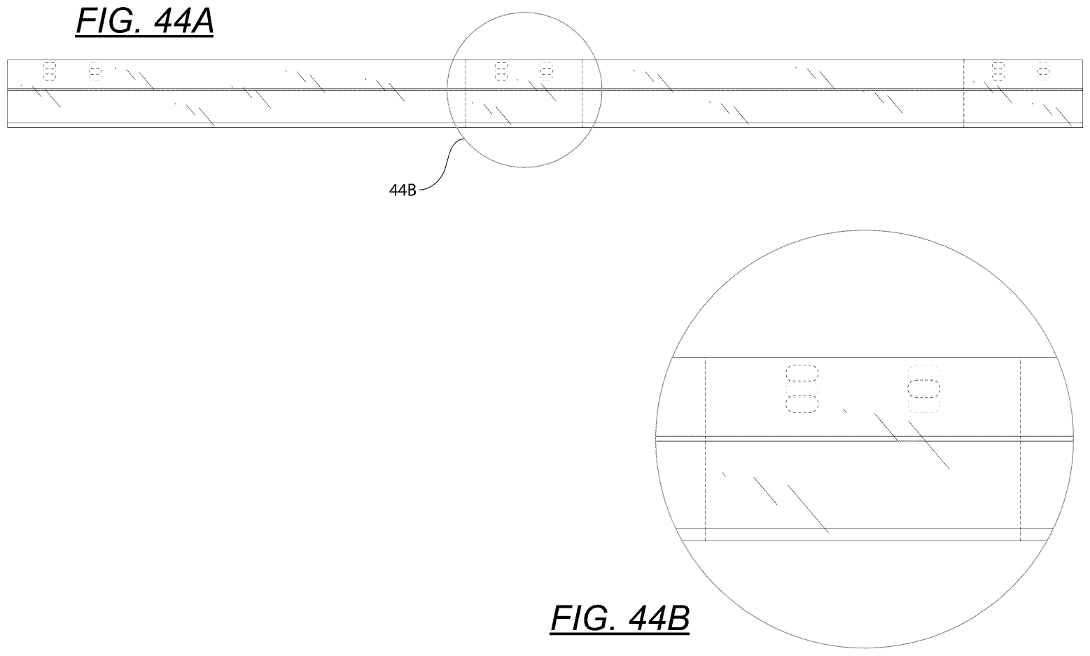

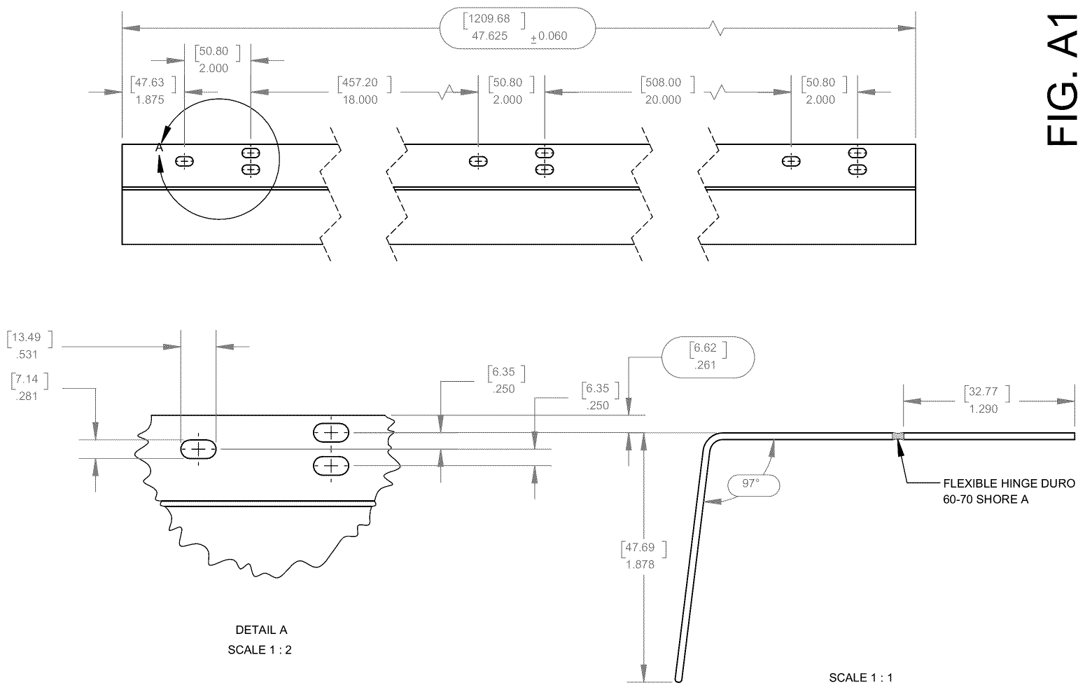

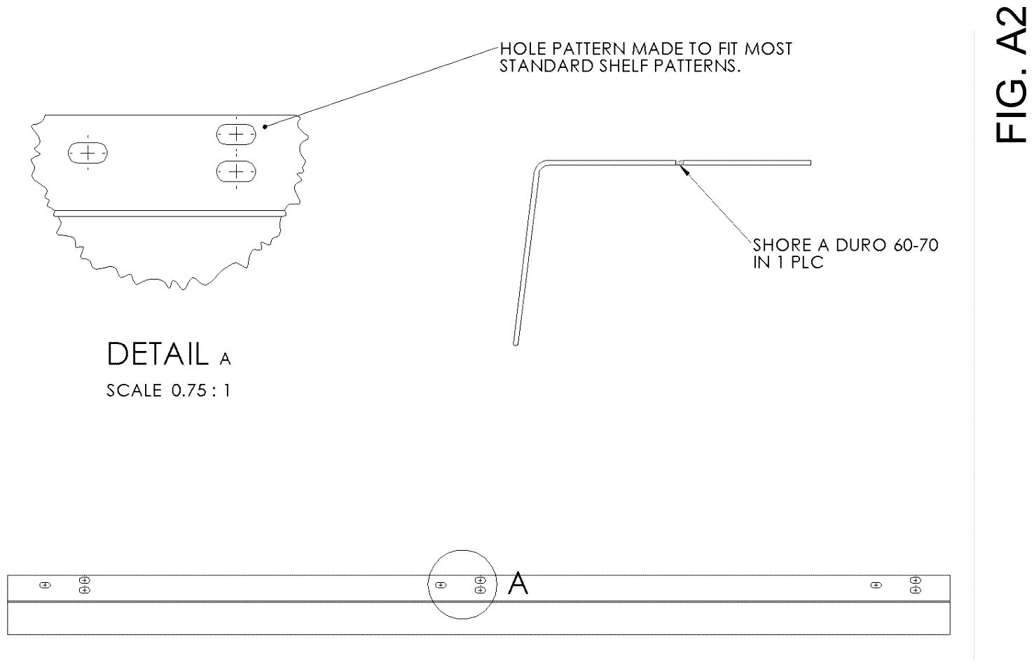

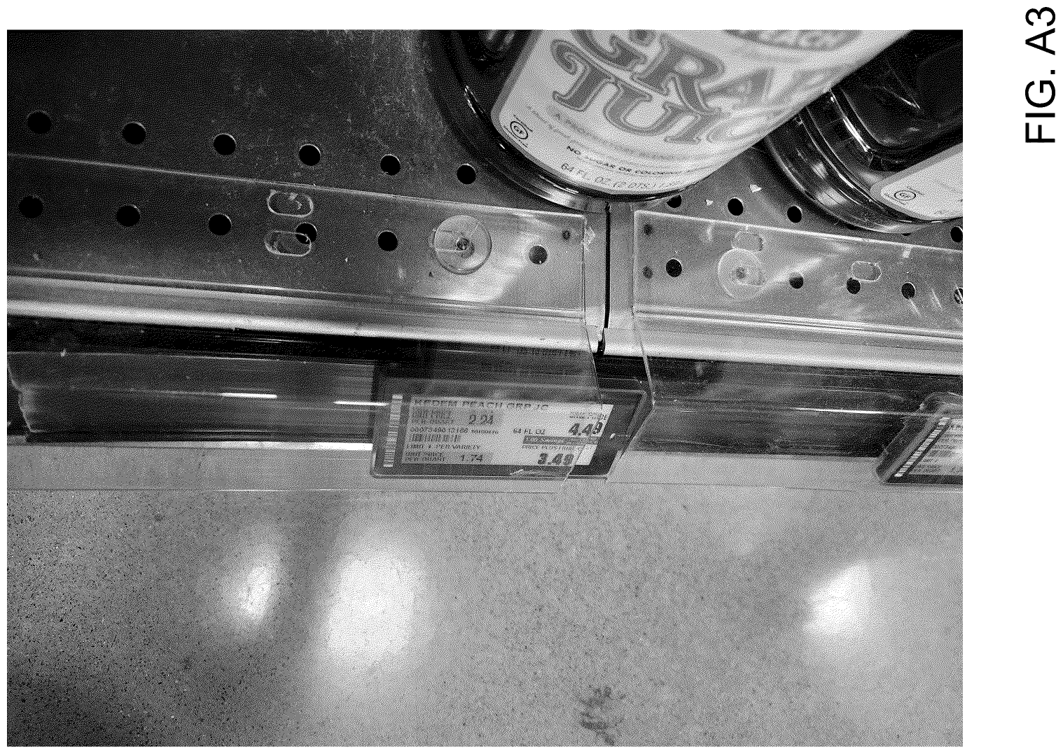

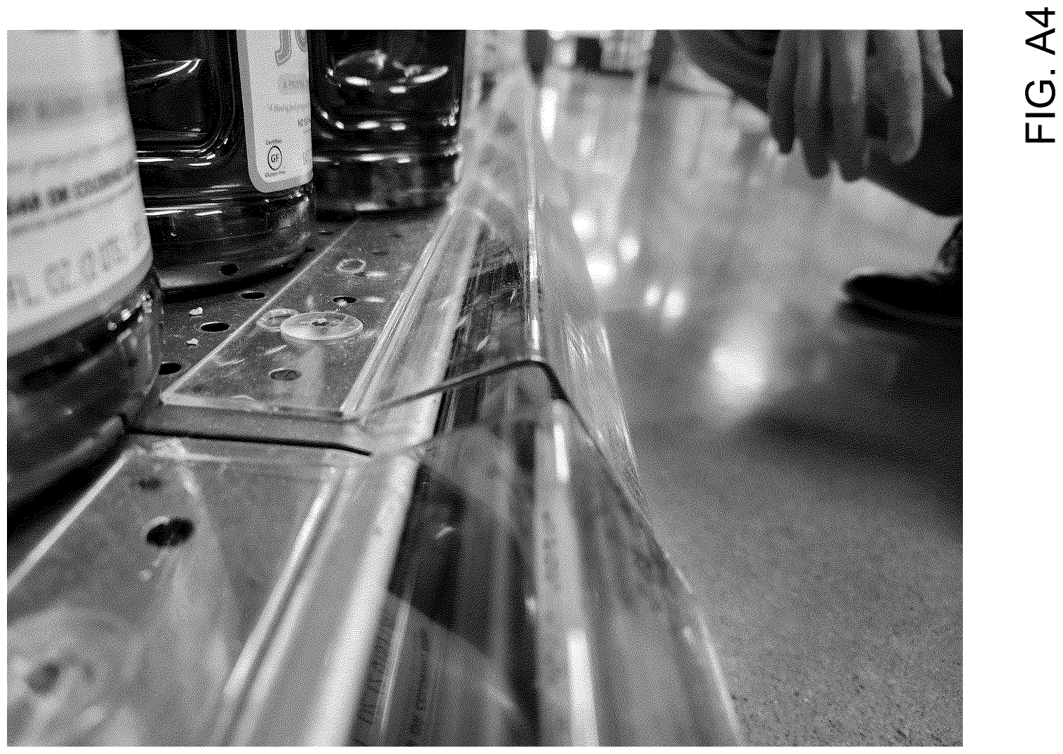

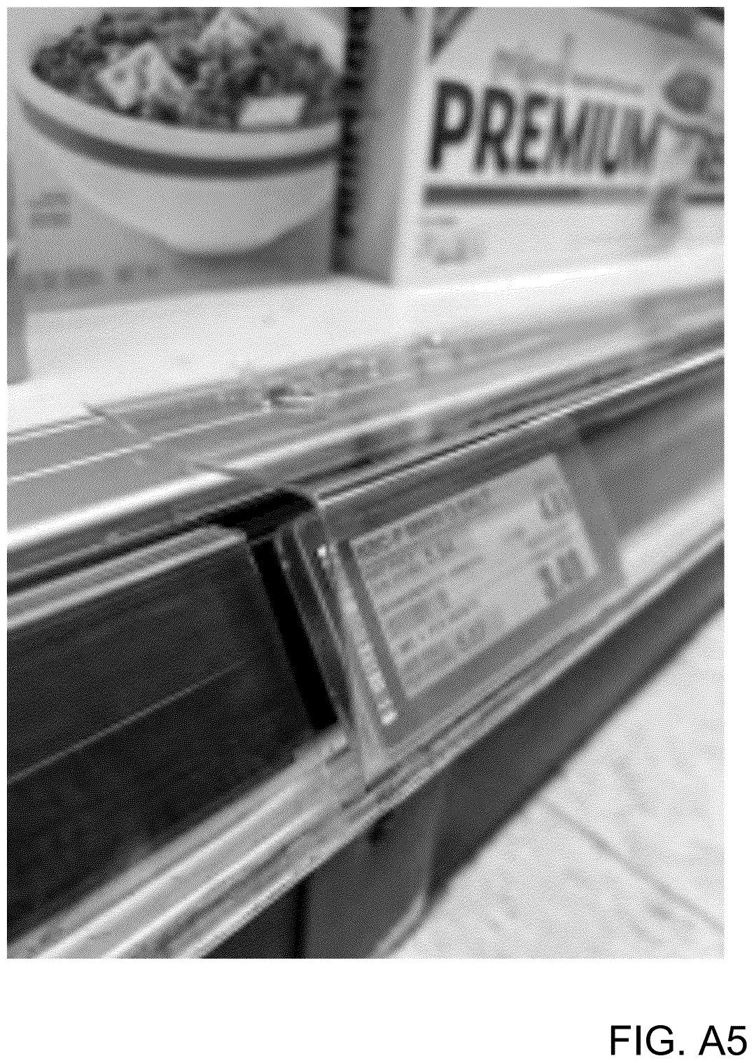

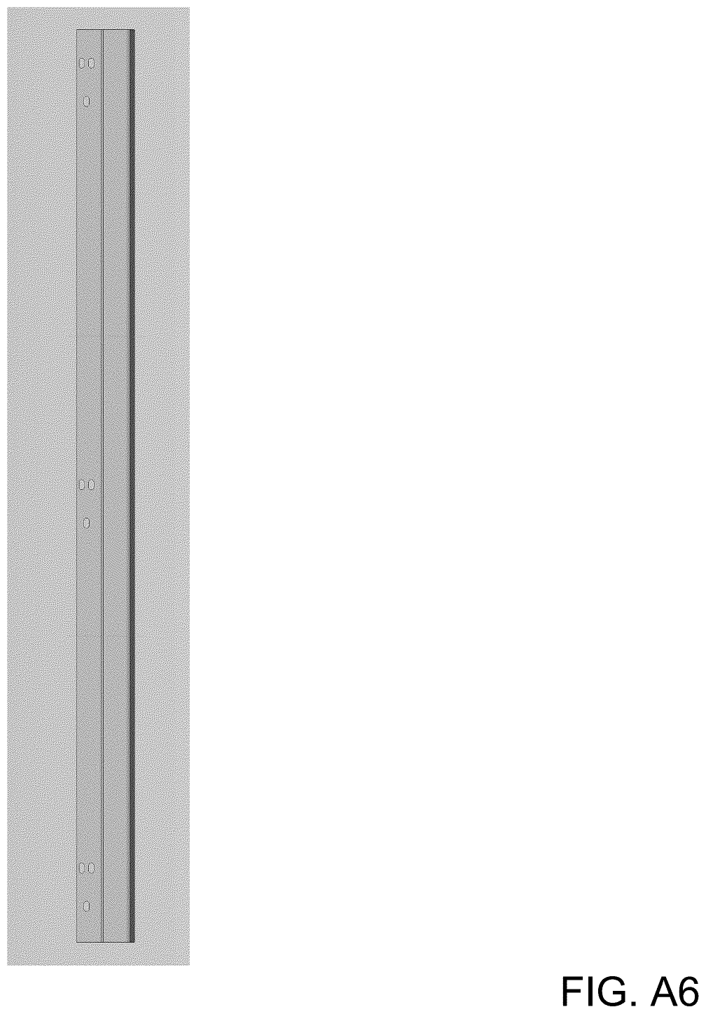

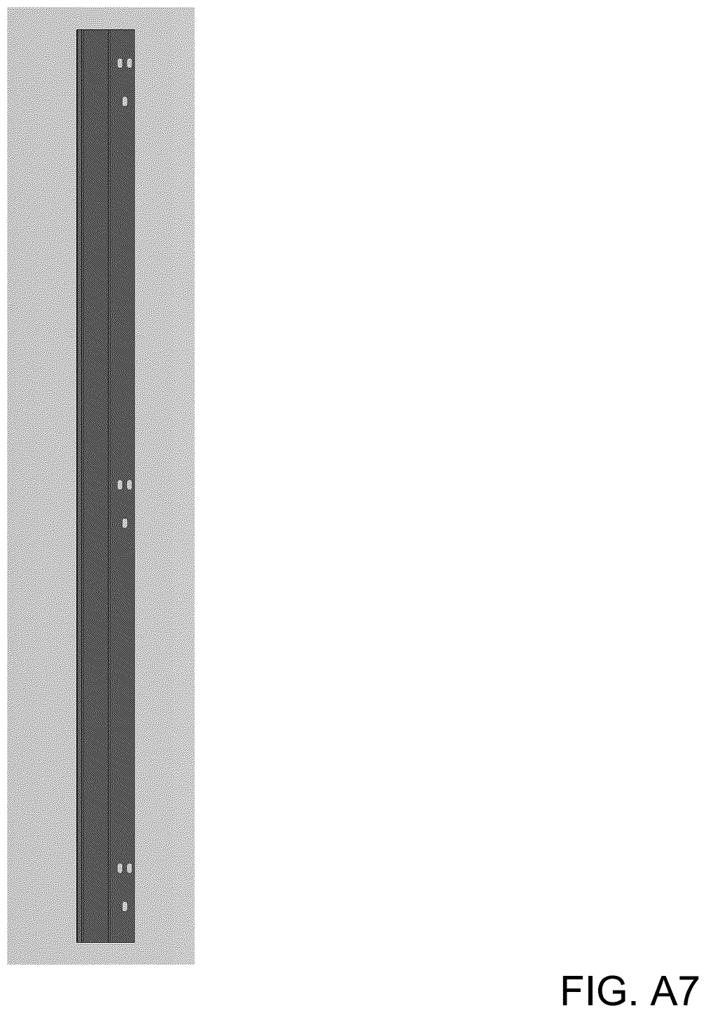

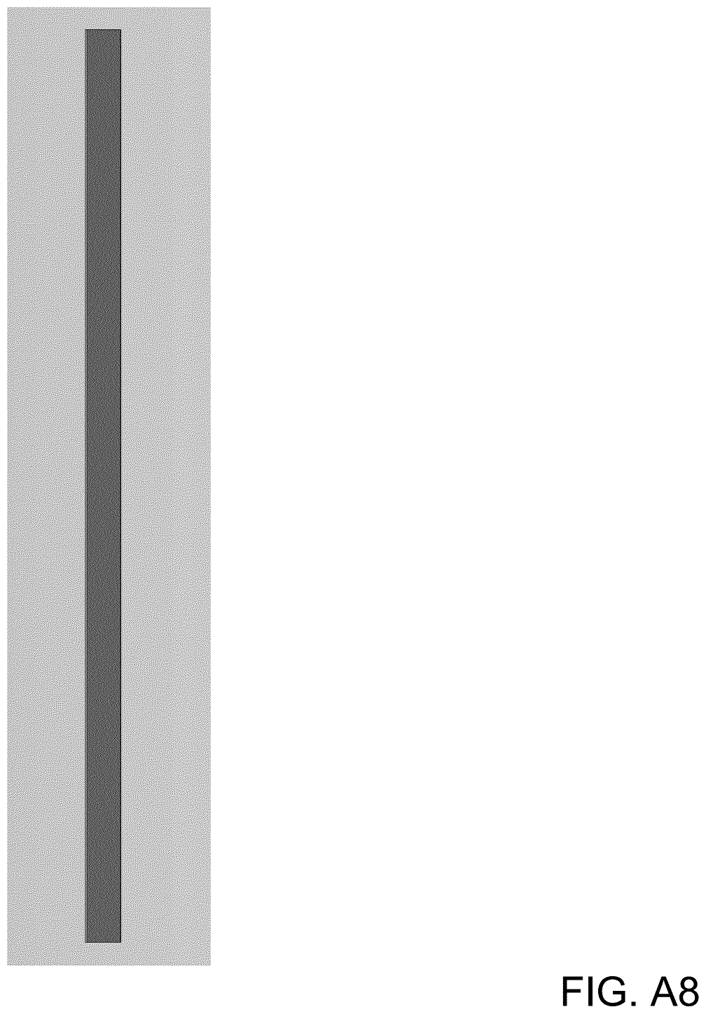

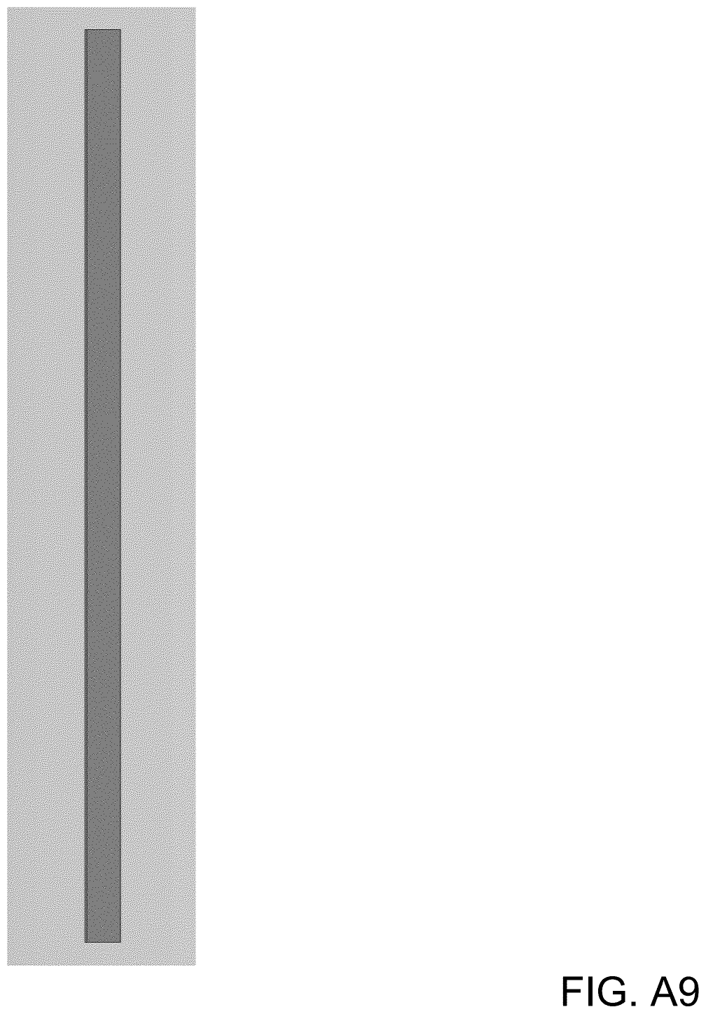

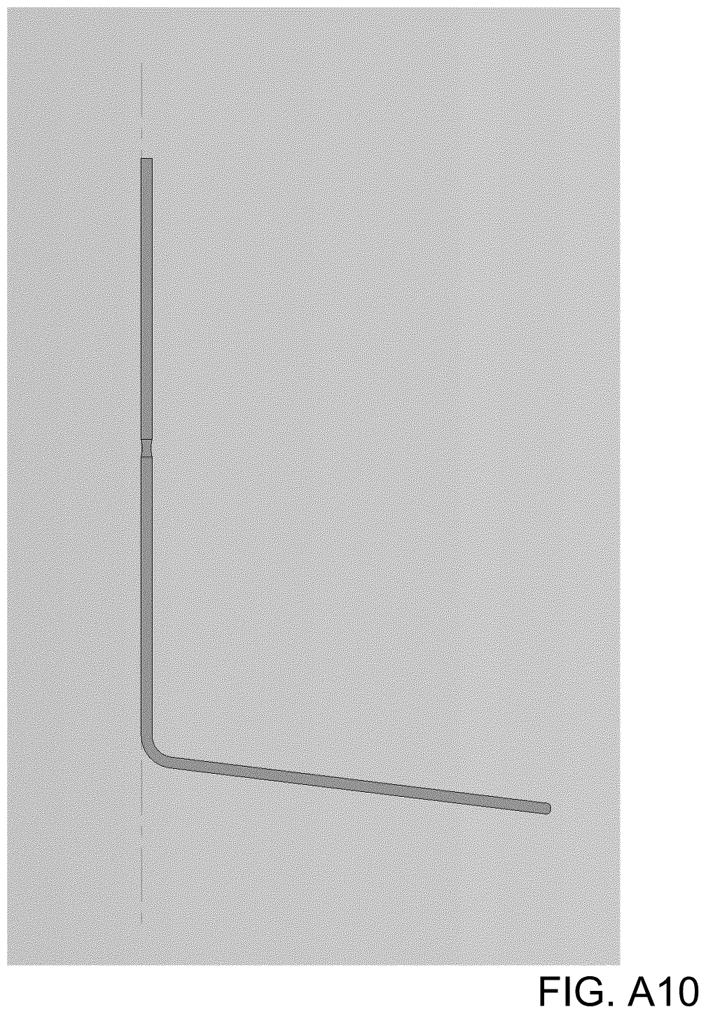

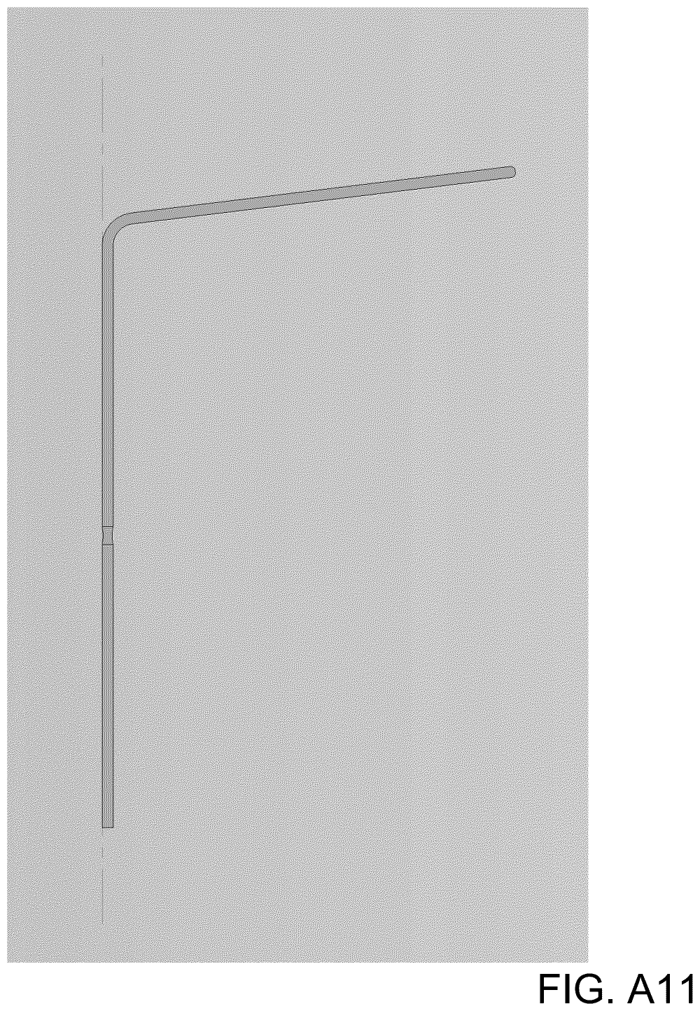

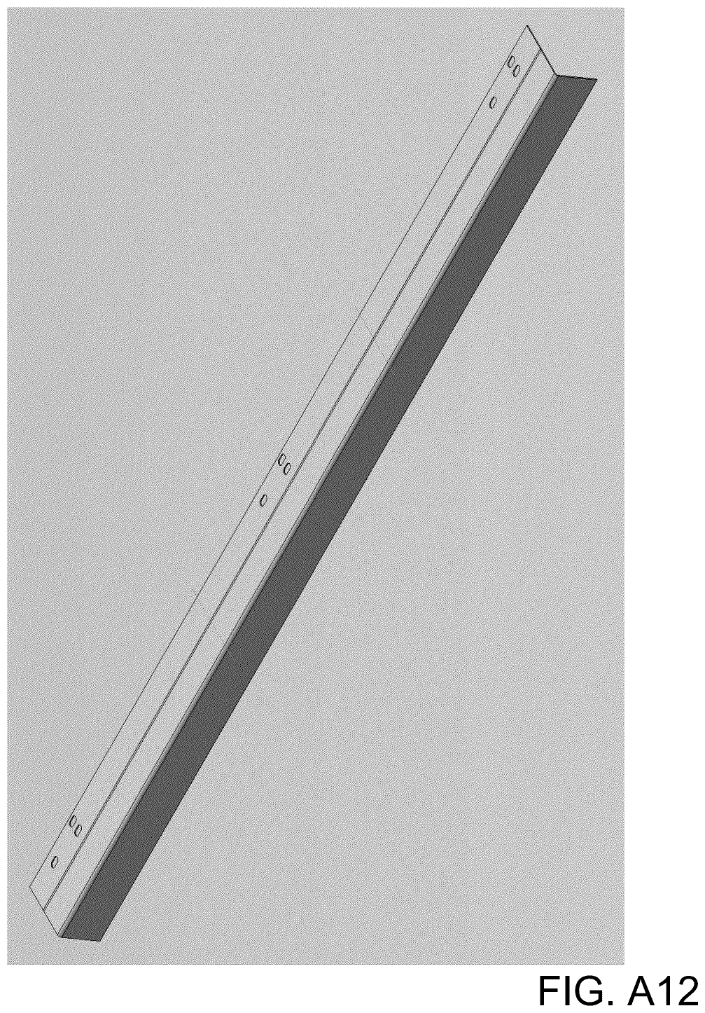

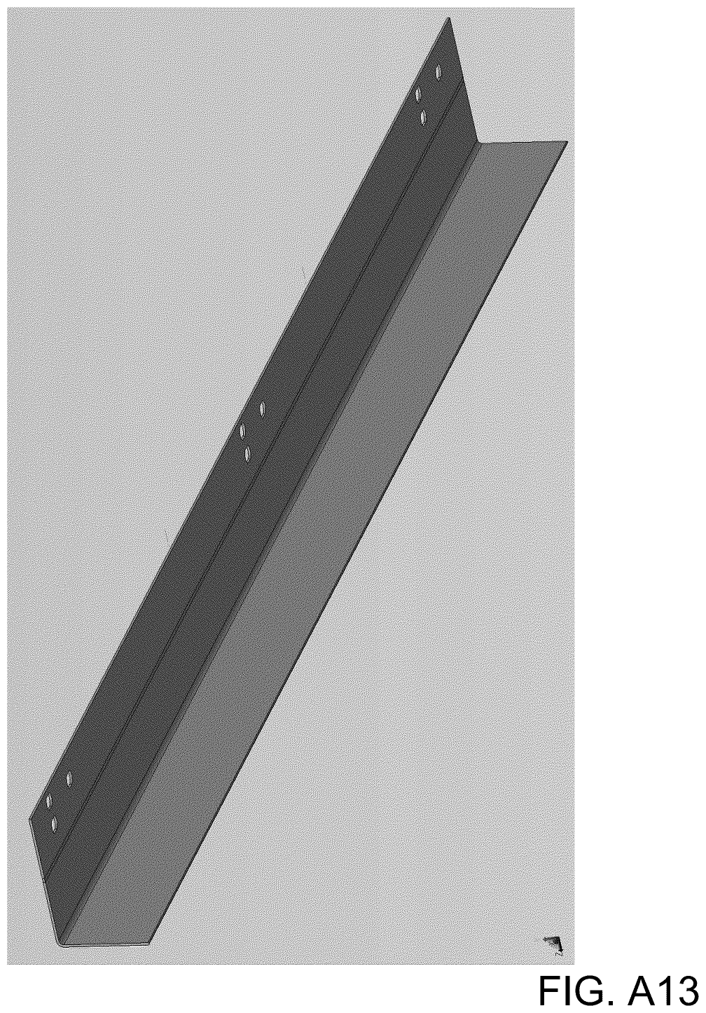

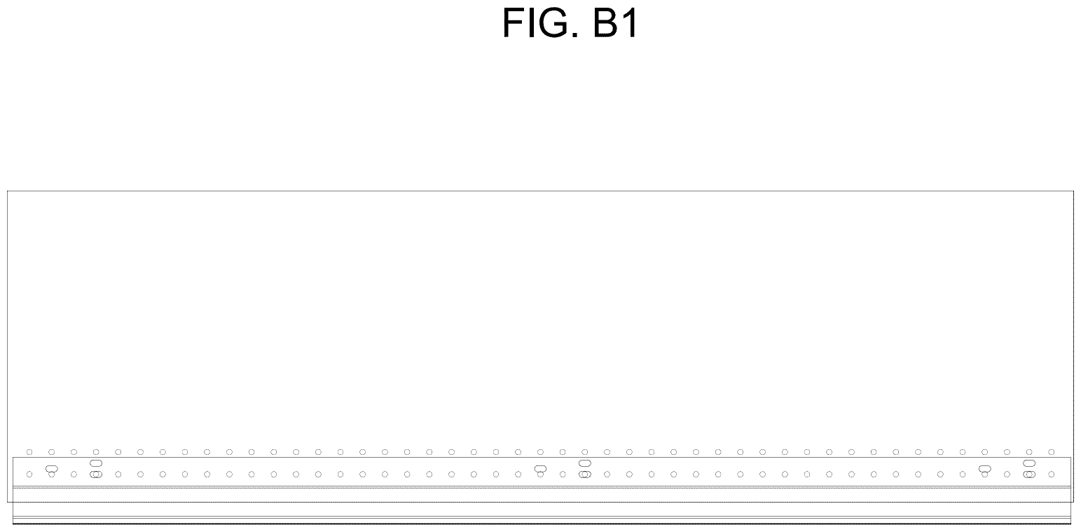

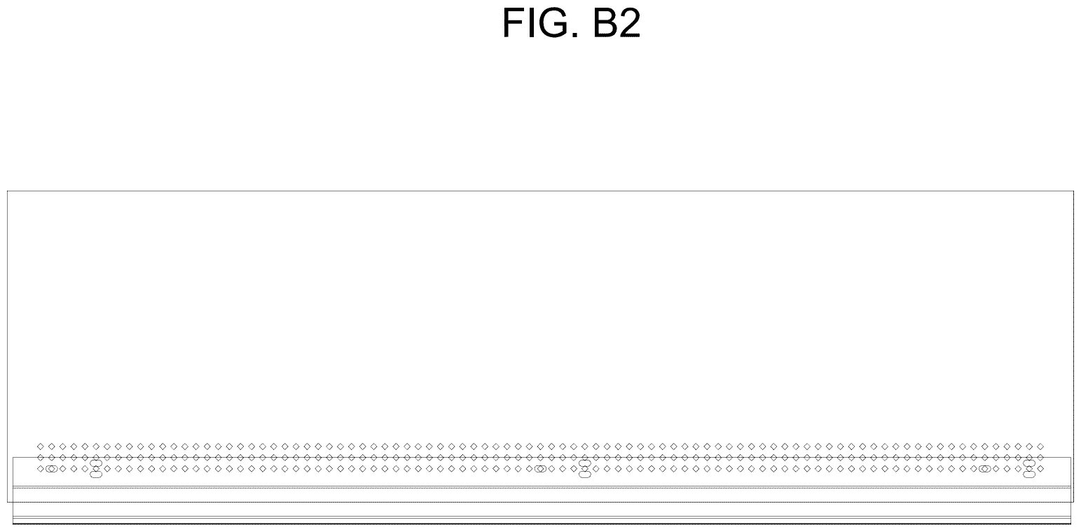

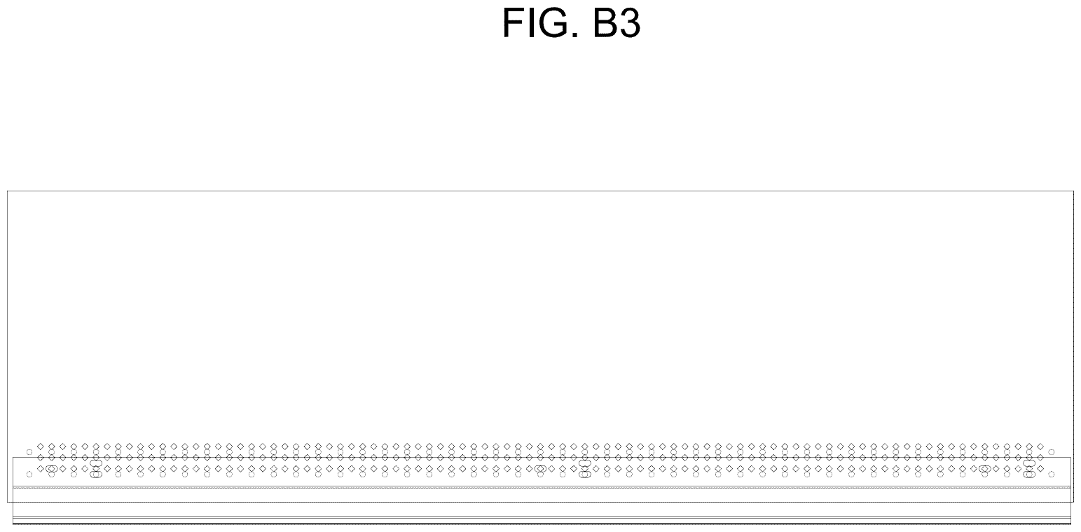

The protection rail 100, 900 may be formed by an extrusion process to form an elongated protection rail 100, 900. As shown in FIGS. 40-44, the protection rail 100, 900 may be formed at various lengths. Exemplary lengths are indicated by dashed lines in FIGS. 40-44. For example, from left to right in FIGS. 41, 43, the protection rail 100, 900 may be formed to include the first and second groups of apertures 102, 104, 106 and terminating after the second group. Alternatively, from right to left in FIGS. 41, 43, the protection rail 100, 900 may be formed to include the third and second groups of apertures 102, 104, 106 and terminating after the second group. As another example, the protection rail 100, 900 may be configured to have a length corresponding to, for example, a single ESL label 54, which could be formed to include only the first group of apertures 102, 104, 106, only the second group of apertures 102, 104, 106, or only the third group of apertures 102, 104, 106. The group(s) of apertures formed by apertures 102, 104, 106 may be similarly or differently configured. For example, one or more of the groups of apertures may include a different number of apertures, size of apertures, and/or arrangement of apertures as one or more other groups of apertures of the protection rail 100, 900. FIGS. 44A-44B show that the group of apertures having 6 stadium-shaped aperture locations shown in dashed line, where the arrangement of apertures for protection rail 100 are shown in greyscale while the arrangement of apertures for protection rail 900 are shown in black. That is, FIGS. 44A-44B show the orientations shown in FIGS. 1-8C and 24-41 overlaid over the orientations shown in FIGS. 9-23, 42, and 43. In this example, each of the aperture groups may include an aperture at one of the 6 dashed locations, or two or more apertures at any combination of two or more dashed locations.

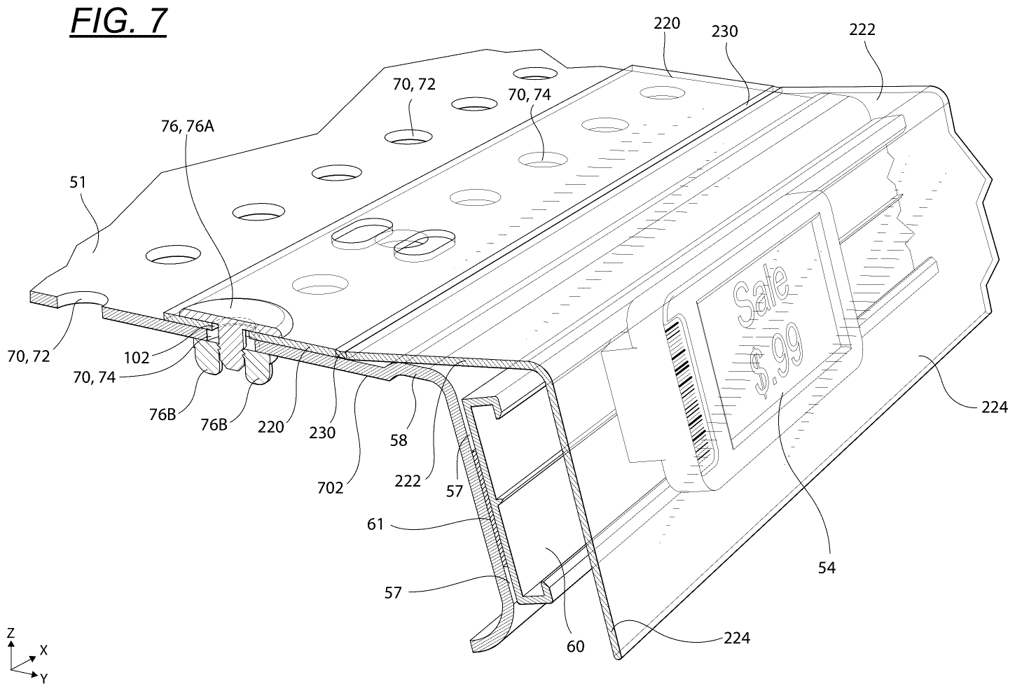

With continued reference to FIGS. 1-6, and further illustrated in the cross-sectional view of FIG. 7, the fastener(s) 76 may engage one or more apertures 102, 104, 106 of the protection rail 100 and one or more corresponding apertures 70 of the shelving unit 50 to fasten the protection rail 100 to the shelving unit 50. For example, as shown, fastener 76 engages and passes through aperture 102 of the protection rail 100 and through the aperture 70 that is at least partially overlapping the aperture 102 in axial direction (e.g., at least partially intersecting). A layout (or pattern) of the apertures 102, 104, 106 of the protection rail 100 may at least partially correspond to a layout (or pattern) of the apertures 70 of the shelving unit so that at least two of the apertures 102, 104, 106 can be arranged in a corresponding (coincident) relationship with two or more apertures 70.

With reference to FIG. 7, the fastener 76 may include a threaded fastener (e.g., bolt 76A and a nut 76B), where the 76B is threaded to the bolt 76A on the bottom surface 702 of the shelving unit 50. The fastening type of the fastener 76 is not limited, and the fastener(s) 76 may include threaded fasteners (e.g., screws, bolt-nut fastener) rivnut insert, rivet, snap rivet, ratchet rivet, key-locking insert, rivets, snap rivet, pins, press-fitting fasteners (e.g., press-fit pins, dowel pins, tapered pins, nail, push-in rivets, expansion plugs, Christmas tree fasteners, peg-back lock), Viking clip fastener, quick-grip washer fastener, thumb snap fastener, expand-a-lock connector, channel fastener, dart clip, push-in clip, arrow clip, fin-type fastener, and/or one or more other mechanical fasteners. Additionally, or alternatively, the fastener 76 may include adhesive, one or more magnets, an adhesive strip, tape, epoxy, an adhesive pad, a magnet strip, hook-and-loop fastener(s), and/or one or more other fasteners.

With continued reference to FIGS. 1 and 7, the shelving unit 50 may include a projection 58 that extends from the top surface 51 of the shelving unit 50. This projection 58 may form a lip on the front of the shelving unit 50 as the top surface 50 transitions to the front edge 57. When the projection rail 100 is mounted to the shelving unit 50 in this configuration, the base portion 222 is pushed up by the projection 58 so that the base portion rotates about the hinge 230 and forms an angled relationship with the mounting portion 220. In this example, the hinge 230 allows the mounting portion 220 to engage the top surface 51 of the shelving unit 50 in a flush engagement to provide a more secure connection to the shelving unit 50. The angled configuration is further illustrated in FIGS. 9-16 and 24-31. FIGS. 2A, 2B, 3, 6, 8A-8C, 17-23, 32-38 and 40-44B show the protection rail 100 in a non-angled configuration (e.g., where the mounting portion 220 and the base portion 222 lay in the same plane). The non-angled configuration may correspond to when the protection rail 100 (i.e., the hinge 230) is in an equilibrium position or state (e.g., a resting or natural state).

As shown in FIG. 2B, the protection rail 100 may additionally or alternatively include one or more other fasteners 240. The fastener(s) 240 may include adhesive, one or more magnets, and/or one or more mechanical fasteners. For example, the fastener(s) 240 may be configured as a strip, such as an adhesive strip, tape, epoxy, adhesive pad, a magnet strip, hook-and-loop fastener(s), and/or one or more other fasteners.

According to aspects of the disclosure, the apertures 102, 104, 106 may be located at positions along the protection rail 100, 900 so as to correspond to one or more apertures 70 of the shelving unit 50. For example, the dimensions of the apertures 102, 104, 106 and associated spatial relationships, as well as the spatial relationship to one or more other groups of apertures 102, 104, 106, may be configured such that the protection rail 100, 900 according to the disclosure may provide a layout of apertures 102, 104, 106 adapted to allow the protection rail 100, 900 to be mounted to various types of shelving units 50 having different aperture (e.g., aperture 70) layouts, different sized apertures, and/or different shaped apertures (e.g., diamond shaped vs. circular shaped). This advantageously provides the protection rail 100, 900 with a universal aperture pattern that allows the protection rail 100, 900 to be universally used for various types of commercially available shelving units, thereby reducing production costs and the requirement to have specialized protection rails for each of the commercially available shelving units.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

1. A protection rail for a shelving unit, comprising:
a mounting portion adapted to attach to the shelving unit;
a base portion connected to the mounting portion; and
a shield portion angularly connected to the base portion and adapted to extend in front of a front edge of the shelving unit.

2. The protection rail of claim 1, wherein the mounting portion comprises a plurality of apertures configured to engage in correspondence with a corresponding plurality of apertures of a surface of the shelving unit, the plurality of apertures of the mounting portion being configured to accept one or more fasteners to mount the protection rail to the shelving unit.

3. The protection rail of claim 2, wherein the plurality of apertures of the mounting portion are arranged in a layout that at least partially corresponds to a layout of the plurality of apertures of the shelving unit to facilitate passage of the one or more fasteners through at least one of the plurality of apertures of the mounting portion and a corresponding one of the plurality of apertures of the surface of the shelving unit.

4. The protection rail of claim 3, wherein the layout of the plurality of apertures of the mounting portion is adapted to at least partially corresponds to two or more different layouts of apertures of two or more different shelving units.

5. The protection rail of claim 1, wherein the protection rail comprises a hinge adapted to rotatably connect the base portion to the mounting portion and allow the base portion and the shield portion to rotate with respect to the mounting portion.

6. The protection rail of claim 5, wherein the hinge continuously extends along a length of the protection rail.

7. The protection rail of claim 1, further comprising a bend portion that angularly connects the shield portion to the base portion.

8. The protection rail of claim 1, wherein the angularly connection of the shield portion to the base portion forms an angle of 97 degrees.

9. The protection rail of claim 2, wherein the plurality of apertures of the mounting portion comprise aperture groups spaced along a longitudinal length of the mounting portion, each of the aperture groups including one or more apertures of the plurality of apertures of the mounting portion.

10. The protection rail of claim 9, wherein the aperture groups comprise three aperture groups, a first of the aperture groups being spaced from a second of the aperture groups by a first distance, and the second aperture group being spaced from a third of the aperture groups by a second distance.

11. The protection rail of claim 10, wherein the first and the second distances are different.

12. The protection rail of claim 11, wherein the first aperture group and the third aperture group are spaced from respective edges of the mounting portion defining the longitudinal length of the mounting portion.

13. The protection rail of claim 10, wherein the first aperture group and the third aperture group are spaced from respective edges of the mounting portion defining the longitudinal length of the mounting portion.

14. The protection rail of claim 9, wherein: at least one of the aperture groups comprises a first aperture spaced from a second aperture and third aperture in a first direction parallel to the longitudinal length, and the first aperture is centrally located between the second and third apertures in a second direction perpendicular to the first direction.

15. The protection rail of claim 1, wherein the shield portion is adapted to shield a label mounted on the front edge of the shelving unit.

16. The protection rail of claim 15, wherein the label is an electronic shelf label (ESL).

17. A protection rail for a shelving unit, comprising:
a mounting portion adapted to attach to the shelving unit, the mounting portion including a plurality of apertures configured to engage in correspondence with a corresponding plurality of apertures of a surface of the shelving unit, wherein the plurality of apertures of the mounting portion being configured to accept one or more fasteners to mount the protection rail to the shelving unit;
a base portion rotatably connected to the mounting portion by a flexible hinge; and
a shield portion angularly connected to the base portion and adapted to extend in front of a front edge of the shelving unit.

18. The protection rail of claim 17, wherein the plurality of apertures of the mounting portion comprise aperture groups spaced along a longitudinal length of the mounting portion, each of the aperture groups including one or more apertures of the plurality of apertures of the mounting portion.

19. The protection rail of claim 18, wherein the aperture groups comprise three aperture groups, a first of the aperture groups being spaced from a second of the aperture groups by a first distance, the second aperture group being spaced from a third of the aperture groups by a second distance, and the second aperture group being disposed between the first and the third aperture groups with respect to the longitudinal length.

20. The protection rail of claim 18, wherein at least one of the aperture groups comprises a first aperture spaced from second and third apertures in a first direction parallel to the longitudinal length, the first aperture being centrally located between the second and third apertures in a second direction perpendicular to the first direction.
